(19) United States
(12) Patent Application Publication
(10) Pub. No.: US 2002/0013834 A1
(43) Pub. Date: Jan. 31, 2002

(54) TRACKING AND GRAPHICAL DISPLAY OF USER ACTIVITY ON AN INFORMATION NETWORK

(76) Inventors: JEFFREY ESAKOV, PENNINGTON, NJ (US); SUZ HSI WAN, PRINCETON, NJ (US); ANSLEY JESSUP, WILLINGBORO, NJ (US); DAVID MICHAEL HUNTER, EWING, NJ (US); LIVIU CHIRIAC, PLAINSBORO, NJ (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(21) Appl. No.: 09/218,564

(22) Filed: Dec. 22, 1998

Related U.S. Application Data
(60) Provisional application No. 60/082,423, filed on Apr. 20, 1998.

(51) Int. Cl. G06F 15/173; G09G 5/00

(52) U.S. Cl. 709/223; 345/736

(57) ABSTRACT

Relationships among a plurality of web pages are indicated to a plurality of users. Icons are displayed, each of which corresponds to one of the web pages. Data associated with each of the pages is maintained for each of the users. This data may exist in the web page or be entered as a notation by each user. Data maintained locally for one user can be provided to another user. Web pages which have already been accessed are also indicated. A map is provided to guide the user so that the user may know which web pages have been accessed, which web pages are to be accessed next and what each web page means to the user Icons are added to the map for each material accessed. Links between icons may be established by the user or by the creator of the map. These links are displayed on the map as a user traverses among the accessible materials. The map may also exist at several levels such that the links and icons at a given level are collapsed into a single icon at the next lower or next higher level when that next lower or next higher level is viewed.

This application claims benefit of the filing date of provisional application No. 60/082,423 filed Apr. 20, 1998.

### FIELD OF THE INVENTION

The present invention relates to the tracking and visualization of access to multiple sources of information. In particular, a method and apparatus are described for tracking and visualizing the accessing of information on a distributed database such as the World Wide Web.

### BACKGROUND OF THE INVENTION

There presently exists many forms of accessing data from a variety of sources. The Internet, for example, has become a significant tool for education and research purposes. Using the World Wide Web, a user is given access to a seemingly unlimited amount of information.

As is known, the World Wide Web is formed of a plurality of web sites. Each web site is uniquely addressed and provides its own information. Web sites may be linked together by hyperlinks. When a page is accessed at one web site, “links” to other web sites may become available. Thus, using hyperlinks, it is possible to go from one web site to another web site. This is referred to as “surfing the web”

At any time, a user may be viewing an image or text from a web site. This is typically done through a software program known as a browser. In this context, there is a great deal of information which the user may not be able to readily grasp:

1) Where am I now?

The user knows the web site he is currently viewing in the browser because the address of that web page (known as the Uniform Resource Locator or URL) may be displayed. What the user does not know is where this site is in relation to other sites in which he is interested. This lack of visible context for the user can prevent him from understanding how the information currently presented in the browser applies to the problem the user is trying to solve.

2) Where have I been?

The user cannot see the web sites which he has accessed before the current web site. Thus, the user is unable to visualize how he arrived at the current web site from the previous web sites which he accessed. This may present a problem, particularly if the user wishes to go back to visit previously viewed web sites.

3) Where am I going?

At the current web site, the user is able to see a plurality of hyperlinks. The user knows that if he clicks on any of these hyperlinks, he will access a page from a web site associated with the selected hyperlink. From the current web site, however, the user does not know which web sites are available beyond a single level of hyperlink usage. Thus, as the user is looking for some type of information, it is often a “hit-or-miss” exercise to find the desired information.

4) What does the above information mean to me?

When viewing a specific web site, the user sees only the information that the web site creator chooses to present. The user is unable to annotate or otherwise personalize the information presented. Thus, the user is unable to combine multiple pieces of information.

A current option available to users of the World Wide Web is the use of bookmarks from within the browser. If a particular web site is of interest to the user, the user can store the URL for that web site for quick access at a later time. Thus, for example, by accessing a “Favorites” menu from the browser, a list of such previously stored URLs may appear. The user may then click on any such URL in order to access the respective web site.

Another option is the use of “personalized home pages” or “portfolios” available from many web sites. If a particular web site is of interest to the user, the user can add it to his personal home page. The personal home page is essentially a list of links.

### SUMMARY OF THE INVENTION

Relationships between a plurality of accessible materials are indicated to a plurality of users. Icons are displayed, each of which corresponds to one of the accessible materials. Data associated with each of the accessible materials is maintained for each of the users. Data maintained for one user can be provided to another user.

### BRIEF DESCRIPTION OF THE DRAWINGS

The invention is best understood from the following detailed description when read in connection with the accompanying drawings. Included in the drawings are the following figures:

FIG. 1A is a flowchart diagram of the server steps taken when a user logs on in an exemplary embodiment of the present invention.

FIG. 1B is a block diagram which illustrates an exemplary embodiment of the present invention.

FIG. 2 is a flowchart diagram which illustrates polling of windows used for tracking.

FIG. 3 is an exemplary screen display in accordance with an embodiment of the present invention.

FIG. 4 illustrates an exemplary screen showing history information.

FIG. 5 illustrates an exemplary screen display which is useful for describing a method of searching for an entry.

FIG. 6 illustrates the results of the search shown in FIG. 5.

FIG. 7 is an exemplary screen illustrating a user's request to display to hierarchical level 0.

FIG. 8 is an exemplary screen display illustrating a user's request to display to hierarchical level 1.

FIG. 9 is an exemplary screen display illustrating a user's request to display to hierarchical level 2.

FIG. 10 is an exemplary screen display illustrating a user's request to display to hierarchical level 3.

FIG. 11 illustrates the hiding of selected entries on a map display.

FIG. 12 illustrates an exemplary map display after designated entries have been hidden.

FIG. 13 illustrates the display of a current path from a selected final node to a root.

FIG. 14 illustrates the display of all nodes.

FIG. 15 illustrates the addition of pages to a map display every time a page is accessed.

FIG. 16 is an exemplary screen display showing addition of pages to the map display from the history display.

FIG. 17 is an illustrative screen display which shows how properties associated with a node may be edited.

FIG. 18 is an illustrative screen display showing how a respective notes may be prepared which correspond to a node on a map.

FIG. 19 is an exemplary screen display which illustrates how various entry properties may be assigned to a node on a map.

FIG. 20 is an illustrative screen display which shows how a user may manually indicate links between different nodes.

FIG. 21 is an example screen display which illustrates how designated nodes may be marked as being done.

FIG. 22 is an example screen display which illustrates the deletion of specified nodes.

FIG. 23 is an example screen display which illustrates the deletion of links.

FIG. 24 is an illustrative screen display which shows that a node, previously marked as done may be modified so that the node is no longer marked as done.

FIG. 25 is an example screen display which illustrates the deletion of nodes.

FIG. 26 is an illustrative screen display which shows that nodes may be arranged in groups.

FIGS. 27A, 27B and 27C illustrate how links are added between nodes corresponding to two pages being viewed in two separate browser windows.

FIG. 28 illustrates a manner of accessing frames within a page.

FIG. 28A illustrates a shorthand string identification for frames in a page.

FIG. 29 is an illustrative screen display of a frame set.

FIG. 30 is a flowchart diagram which illustrates the visualization applet's updating internal data structures.

FIG. 31 is an illustrative screen display which illustrates a display of nodes using a textual view.

FIGS. 32A and 32B illustrate an example layout of a multi-dimensional map.

FIG. 33 is an illustration of a database schema for an exemplary embodiment.

FIGS. 34A and 34B are map diagrams which illustrate an example embodiment for placement of nodes when copying from the history table to the map.

### DETAILED DESCRIPTION OF THE INVENTION

The present invention is embodied in a navigation system for a distributed database system. The invention allows the user to identify previous sources from which the user has obtained data. The invention also allows the user to identify sources of data which are available to the user but which have not yet been accessed. The invention may be embodied in a computer program which may be conveyed on a carrier such as a magnetic or optical disk device or a modulated carrier wave.

A particular application of the present invention is for the tracking of data access while on the World Wide Web. As is known in the art, the World Wide Web is composed of various data sources (web sites) which are interlinked through the use of hyperlinks. Each web site transmits data in the form of pages. An individual may visit a page by specifying a Universal Resource Locator (URL).

Pages may be viewed using an application referred to as a browser. A browser accesses a server to obtain pages to be displayed. A page may be segmented into separate portions referred to as frames. Frames may be visible and they may not be visible. Thus, for example, on a page, there may be two frames which are not visible to the user and a third frame that is visible. Frames are useful because they allow applications such as JavaScript and Java to be loaded into HTML pages without taking screen space. Data can be shared across frames using browser languages such as JavaScript and Java.

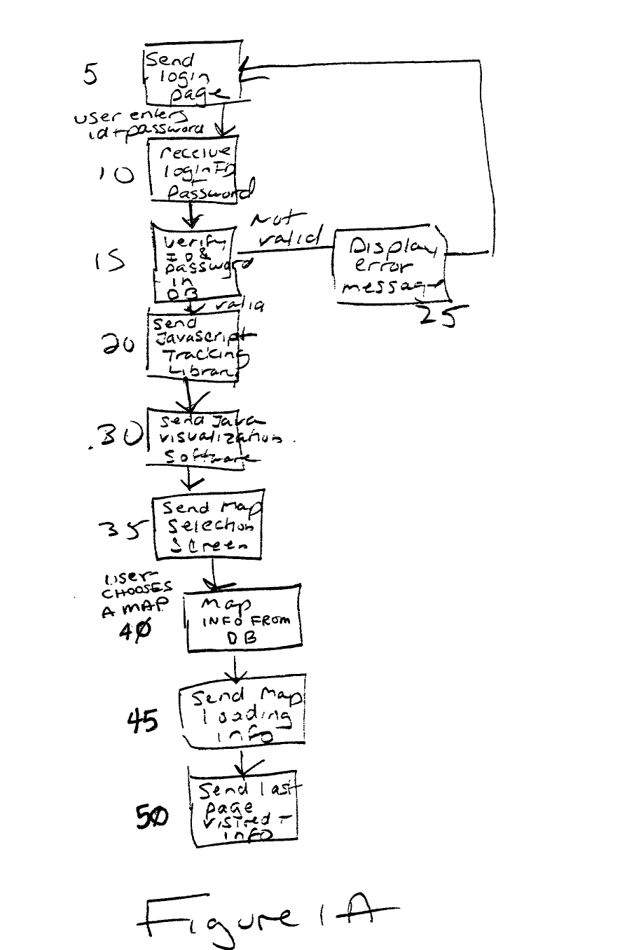

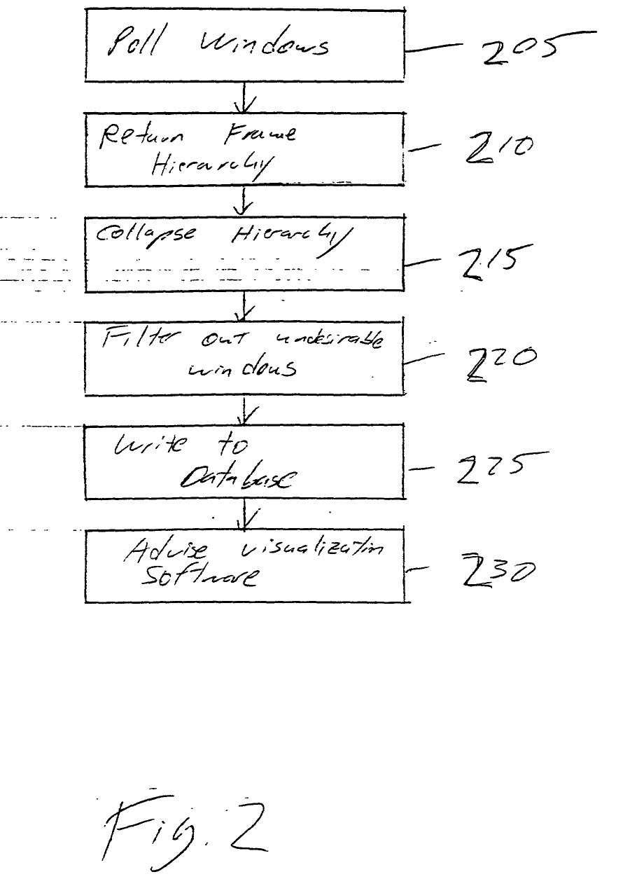

FIG. 1A provides an overview of an exemplary embodiment of the present invention. Operation begins with an individual visiting a page in which at least portions of the present invention reside. The individual visits this page by specifying an appropriate URL in the browser and the page is transmitted to the user (step 5). Then, in step 10, the user may be asked to enter a user name and a password. A database is accessed to verify the user name and password in step 15. JavaScript may be downloaded, then a display in accordance with an exemplary embodiment of the invention may be presented to the user, as shown in steps 20 to 50 and as described below with reference to FIGS. 3 to 25.

The functional block diagram of FIG. 1B illustrates another embodiment of the present invention. The bottom half of FIG. 1B represents the client machine 110. The client interacts with the standard browser software 113 that communicates transparently with the tracking facility which is comprised of the tracking daemon 112 and the tracking client 114. Alternatively the tracking daemon 112 and the tracking client 114 can reside within the browser environment 113. Similarly, the visualization facility can also be implemented using this architecture.

High level operation of an exemplary embodiment of the present invention is illustrated, for example, with reference to the block diagram of FIG. 1B. Clients 110 may be, for example, individual personal computers (PCs) connected to the server via a local area network (LAN). Clients 110 allow respective users to view appropriate screen displays in accordance with an exemplary embodiment of the present invention. Also, shown in FIG. 1B, is web server 115. While the browsers can access any Web server for general Web pages, Web server 115 is responsible for downloading the software of the current invention to appropriate clients. Web server 115 obtains page contents from database 120. As shown, web server 115 may transmit various frames to various clients. Each client has dual capability. The first capability of each client is referred to as visualization. Visualization allows an individual to view the relationships between various sources of data (e.g., web pages). The second capability of each client is referred to as tracking. Tracking enables a user to be shown which pages data have previously been viewed and which pages are currently being viewed. Thus, each client may have both visualization and tracking in use. One aspect of visualization is referred to as a map. The data which specifies each client's map may be stored in database 120. As a client's map is modified these modifications may be reflected in the version of the client's respective map which is globally available via the database. Each client may transmit these modifications to the database via a hidden frame. In addition, each client may transmit tracking information to the database via a hidden frame.

The visualization and tracking facilities referred to above may be concurrently executing from within the browser. Because the visualization/tracking is located in the browser, frames can be identified. Thus, the browser has complete information regarding window configuration. An exact window configuration can be reproduced at the browser level regardless of client updates to that window configuration.

A database which includes data associated with each user's map and tracking data may be implemented as a centralized database 120, accessed by all clients via a web server. In one implementation of the system, the database is co-located with a web server on a centralized computer, separate and distinct from any individual client. With this implementation, the web server is used to extract the information from the database using database-specific commands and reformat the data for transmission to the client. Referring again to FIG. 1A, in step 45, the data can be encoded as a series of JavaScript statements that are transmitted to the browser using a standard Web protocol (HTTP) and are then executed in the browser. The statements may consist of JavaScript variable assignments or a set of function calls to the visualization software.

To save information back into the database, the tracking and visualization software may utilize a standard Web protocol. For example, the Hypertext Transfer Protocol POST command could be used to send the data to the web server that stores the information in the database.

In an alternate implementation, each user may have a personalized database co-located with their browser on their personal machine. To share information with another user, the database may be configured as a shared resource (i.e., with a server accessible to other users). Alternatively, the user may export data and send it to other users to import into their database.

Thus, other users are able to view modifications which individuals make to their respective maps. For data to be shared with different users who generated the data, a mechanism is provided to identify the data with the respective users. In one implementation for sharing data among users, an individual user can call up a list of users that have access to a particular named map. Since each user has individual copies of the named map, that user can view the maps of other users. Also, appropriate security measures (e.g., read-only files) may be desirably provided.

Tracking is performed as follows. It is assumed that the tracking software has been previously downloaded and is currently running as a result of the log-in procedure. Tracking software routinely polls open windows to determine which URLs are displayed in the respective windows. Accordingly, the URLs which make up the frames are polled. Start times and end times for each URL are recorded. Thus, a frame may be used for reporting information from the tracking routines to the database. While, in one exemplary embodiment of the present invention, the frame may be transmitted to the database, in an alternative aspect of the present invention, the frame may also be transmitted directly to the visualization component of client 110.

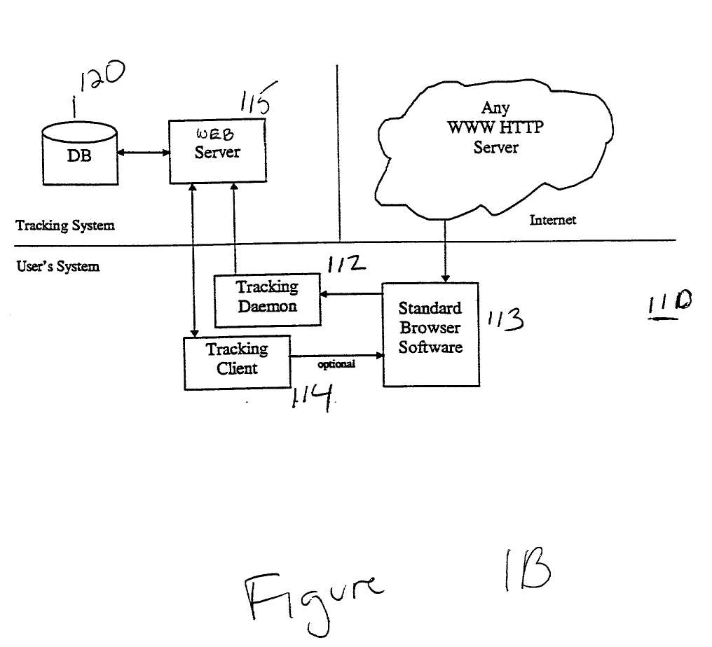

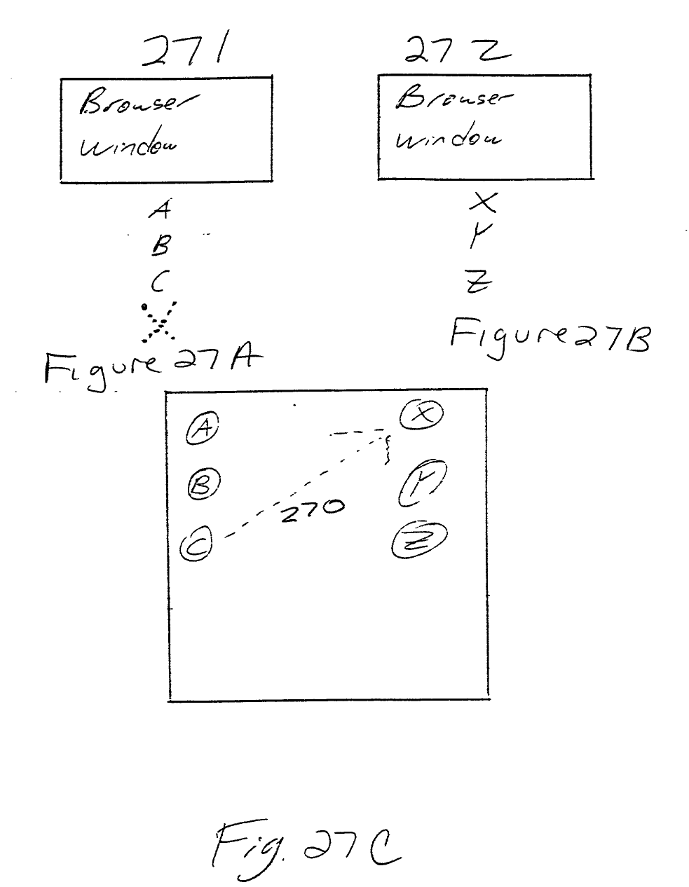

The polling of a window by the tracking software is accomplished in accordance with the flowchart diagram shown in FIG. 2. In particular, there is a list of windows which are trackable windows. At step 205, this list of windows is separately polled. At step 210, a frame hierarchy is returned as a result of the poll which, in the exemplary embodiment of the invention, is a call to a standard browser status function. At step 215, the hierarchy is collapsed into a string which represents frames occupied by the contents of the window. One of ordinary skill in the art will recognize that there are various ways in which a hierarchy of frames can be encoded. Appropriate delimiters and level numbers may be inserted as desired. An example of URL translation with frame hierarchy is shown in FIG. 28. FIG. 28 illustrates an example of a string representation of the frames within a window. If another window is opened by selecting a hypertext link, that window is tracked. Conversely, a window which is opened by selecting a pull down menu may or may not be tracked depending upon the specific browser implementation.

The extent of tracking is dependent upon the browser implementation. In some browsers, tracking is permitted only on windows that are opened when selecting hypertext links from a window that is already being tracked. In these browsers, the initial tracked window must explicitly (through JavaScript) be marked as trackable. In some browsers, it may not be possible to track the contents of windows opened through menu operations or through arbitrary window operations. In other browsers, it may be possible to track the contents of all windows, regardless of how they are created.

At step 220, undesirable windows may be filtered out. While the tracking software always notes the window contents, it may not always be desirable to store the tracking information in the database or to indicate the contents of the window to the visualization software. Such a case can occur when, for example, a window describing the browser version is displayed (which is often selected using a Help menu option in ordinary browsers). The “undesirable” windows are indicated in a list that is maintained in the tracking software (and is considered part of the software system). Each time a window is polled, the contents of the window are compared to each item in the list. If it does appear in the list, the window is ignored (until the contents of the window change).

At step 225, the data corresponding to the URL being displayed is written to the database. A hidden frame may be used to write this frame to the database 120. At step 230, the visualization software is informed of the data corresponding to the URL which has been opened in the window. In the exemplary embodiment of the current invention, the visualization software is notified of the currently displayed URLs via a function call from the JavaScript tracking software directly to the Java visualization software. The visualization software may display a graphical indication of the current URLs on the map. One of ordinary skill in the art will recognize that communication between the database and the web server may occur in a variety of ways. This may be accomplished, for example, using Netscape Enterprise Server with Live-Wire Pro or any other commercially available software which is used for Internet access and communication.

Next, referring again to FIG. 1A, log-in is described. Log-in enables a user to begin visualization and tracking. This exemplary embodiment is described with reference to JavaScript. However, one of ordinary skill in the art will recognize that other software packages, such as C++, may be used. First, the step of layer initialization may occur. This may include, for example, indicating whether certain layers are visible to the user. Thus, initially, only the log-in form may be visible as shown in step 5. Using this form, the user is permitted to enter log-in data. In step 15, when the log-in data is submitted to the server, it may be validated against the user information stored in the database using, for example, Server-Side JavaScript. If the data is found to be valid, the user is permitted to proceed. As with other procedures used for software log-in, identification of the user may be transmitted to other aspects of the system. Thus, the server maintains identification of the individual user. In this way, the server is able to make appropriate updates to the database entries associated with each specific user.

Next, the HTML is generated. This is accomplished by generating the frames associated with the invention. These frames may be, for example, a frame which lists courses that the user (who is a student) interacts with, a hidden frame which references the database interface, and a hidden frame into which the Java program is loaded. Tracking software is also downloaded.

Next, for example, a student may select a course.

In this exemplary embodiment, a plurality of hidden fields are associated with each course. When requested by a student, data corresponding to such information such as course identification, student identification, etc. is transmitted to an appropriate routine which causes the course data to be downloaded. If the course has previously been opened, a window is opened with the last URL that had been displayed. If the course has not previously been opened, a page associated with the course as specified by the course designer when the map was created, is opened by the browser. The map data associated with that course is also downloaded. This map data is thus downloaded from the server to the hidden database frame previously described. In this manner, the map is populated and the log-in operation is completed. The visualization software uses an event-driven model well-known to those with ordinary skill in the art. In the exemplary embodiment, events may be initiated by either the user interacting with the software via the user interface, or from the JavaScript tracking software.

Referring to FIGS. 1B and 2, steps 205, 210, 215, 220 and 230 may be executed by each client 110.

As previously described, an exemplary embodiment of the present invention relates to different individuals taking various academic courses. Each course may be arranged in such a way so that the student is expected to visit various web pages. As described above, the user may use the exemplary system to select a course. The last page that was displayed to that user in a previous session is displayed as the first page in the new session. The visualization map is then displayed. It is then possible to navigate (surf) using a browser or through the visualization map associated with an exemplary embodiment of the present invention. This is illustrated, for example, by FIG. 3 which shows a screen display with various nodes corresponding to various web pages. The user is expected to access web pages in accordance with their corresponding nodes as shown on the screen.

The loading of web pages in the browser through the use of the map is accomplished via a simple user paradigm. When a user positions the mouse cursor over an icon and presses and releases the mouse button twice in rapid succession (“double-clicks”), an event is generated in the visualization software. The event handler recognizes the event and the icon that is associated with the event. Since each icon represents a web page address (URL), that URL is known and the visualization software sends a command to the browser using a browser-defined function call to open that address. In the exemplary embodiment, when a page is opened via the Java application, it uses the browser interface to call a JavaScript function to insure that the window that is opened is added to the list of trackable windows.

At this point, the event-handler for navigating to a specific page via the visualization software is complete. However, by virtue of opening a new window (or changing the page in an existing trackable window), a new event is generated by the JavaScript tracking software to indicate the page change.

This visualization map may be implemented, for example, using Java. It may also be implemented in other languages, such as, C++. The visualization map uses a directed graph visualization technique. Assume that a particular web page is in a browser and is being viewed by a user. This may be indicated, for example, by enlarging the icon corresponding to this current web page. If several pages are open in the browser, then multiple icons may be enlarged. Other forms of highlighting may be used, for example, such as making text bold, colored, etc. Other techniques may be used to show web pages which the user has previously accessed. Thus, for example, the icons corresponding to the web pages which the user has previously viewed but which are not currently being viewed, may be shown by creating an appropriate modification to those icons. These modifications may be referred to as decorations. An exemplary decoration for an icon corresponding to a previously visited web page may be, for example, to show the icon in faded form. Web pages which have not yet been visited, but which may be available to the user, may be indicated by showing corresponding icons.

The icons shown in the map do not represent the only web pages which the user may visit. The map simply illustrates possible web pages which may be accessed by the user. Typically, any publicly available page on the World Wide Web may be accessed by the user. Thus, one may access pages which are indicated by the visualization components or pages which are not indicated by the visualization components. The map simply represents one possible organization of this information. Furthermore, while relationships are shown between the icons, this can be different from actual links (hyperlinks) on the web pages themselves. Thus, the visualization map provides the user with a variety of options.

1) First, the user has the ability to modify the layout. This means that the location of icons on the screen can be changed. The standard “drag-and-drop” paradigm is used to move icons. The user places the mouse cursor over the icon to be moved, presses the button and drags the icon to the new position. Any links attached to the icon will automatically be redrawn to stay with the icon. When the user modifies the map in such a manner, visualization software will update the database entry for the icon to reflect its new position (in the x-y coordinate system). Although the location of icons on the screen may change, the directed graph remains the same.

Icons can also be deleted.

2) Next, the user has the option to add links. These are not hyperlinks as are found on the World Wide Web. Rather, these links show a relationship between pages that the user, as opposed to the page creator, wishes to capture. These links can also be annotated as will be explained below.

Links are used to visually represent relationships between pages. Links may be pre-defined by the original map author, or may be created by the user. The relationships represented by the links can be based upon any criteria the user chooses. For example, links may be used to show a series of pages that represent a process, or links may be used to show topic/sub-topic relationships.

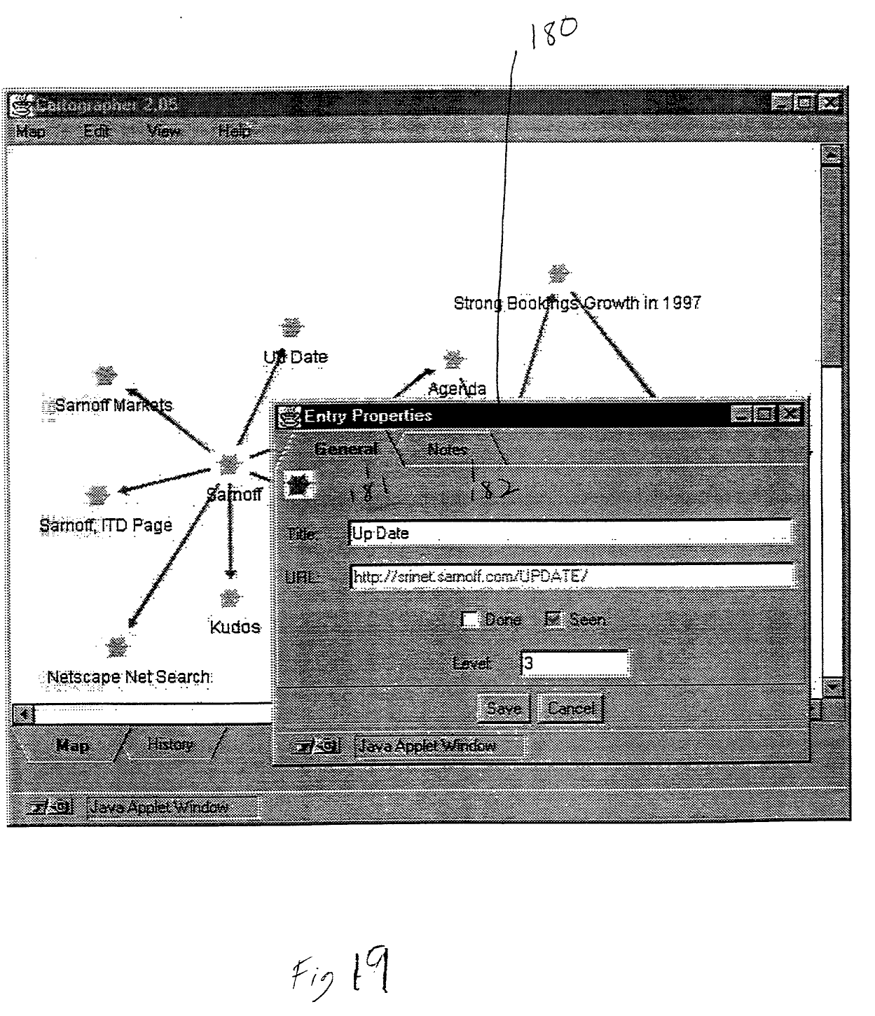

To create a link between icons, the user selects one icon, then chooses the “Link to” option from the menu (FIG. 20). The user then selects another icon and a link is drawn between the two. Furthermore, the visualization software will then update the database to indicate the creation of the link.

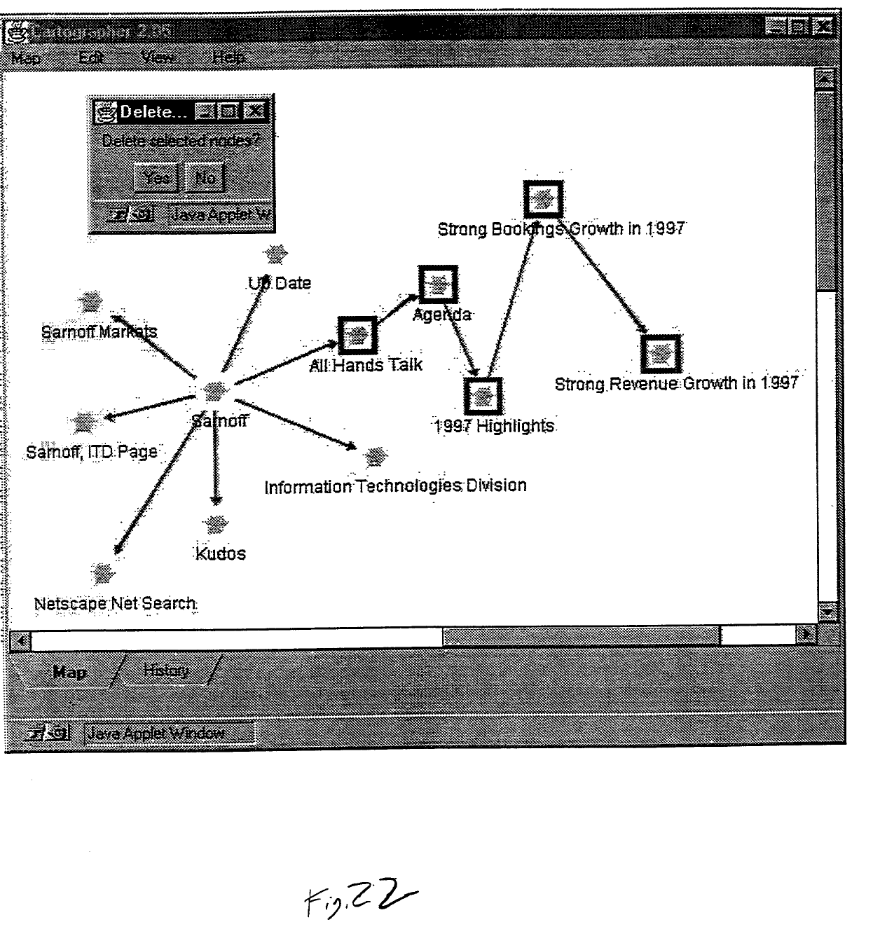

Similarly, links may be deleted if the user desires. See, for example, FIG. 23.

3) The user is able to add notes regarding each page or link. Thus, text, of the user's choosing, may be associated with an icon or link. When an icon or link has a note, it can be decorated to indicate that state.

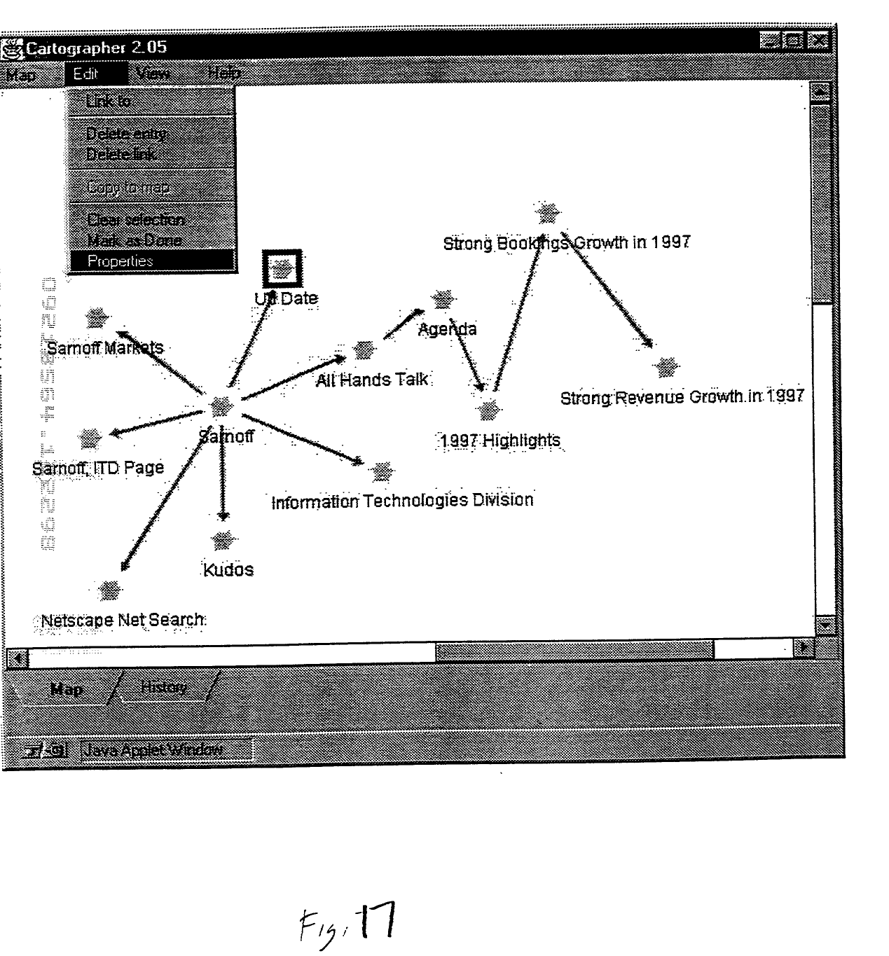

To create, or edit an existing note, the user selects one icon, then chooses the “Edit Properties” option from the menu. The properties dialog 180 will be displayed as in FIG. 18 (or 19). The user should select the note option 182 in the dialog box and then type the new note. The note is associated with the icon and will be saved to the database when the user uses the mouse to select the “save” button in the properties dialog window.

In the exemplary embodiment, when a map is shared among users, all information associated with the map is made available. Hence, notes are shared. One skilled in the art can see that separate access control lists may be created for the information associated with an icon (or a link) to prevent the sharing of, for example, notes while still sharing the overall map structure.

Notes are just one form of adding information to an icon or link. The user can also add structured information in the form of general attributes to each icon or link. The attributes, know to one skilled in the art, can be in the form of tag/value pairs.

4) The title is often the title which is specified in the HTML. If no title is specified in the HTML, then the URL string may be used. The user is able to change the title associated with each icon. It is noted, that these titles may be (and often are) different from the actual URL associated with that page. Thus, the title which the user may assign to the icon may be a name which is meaningful to the individual user.

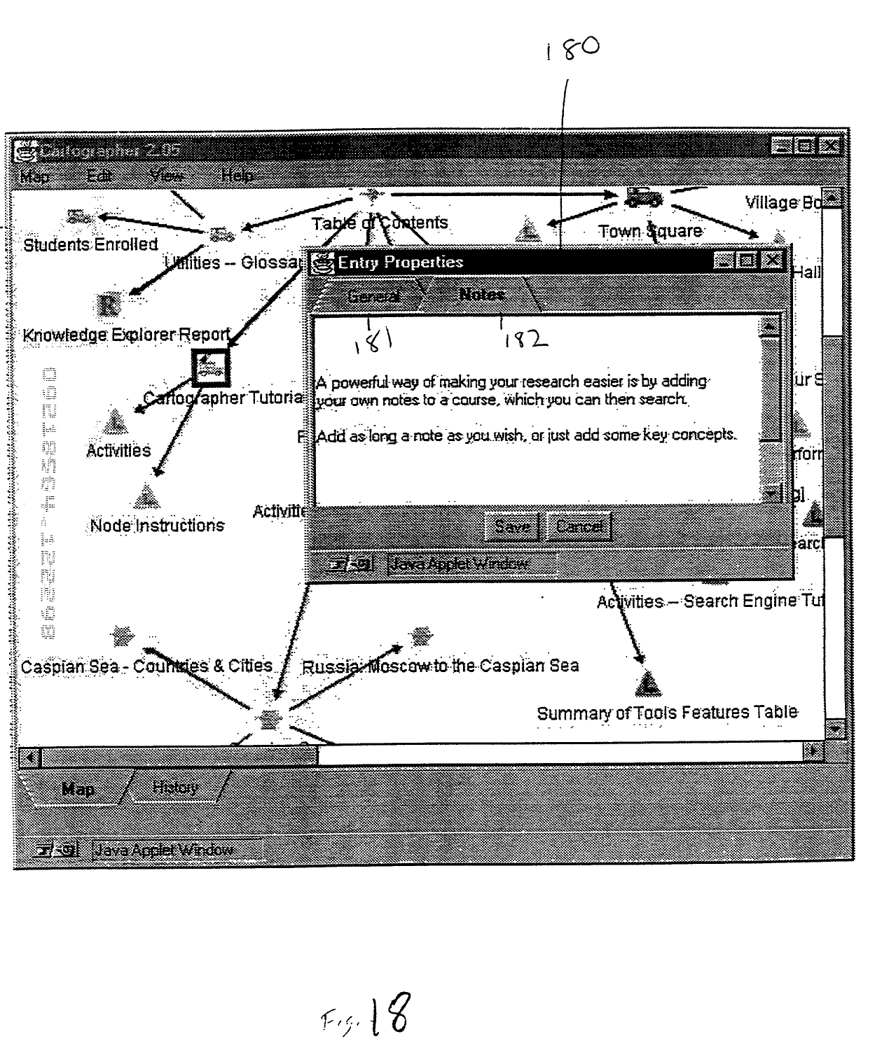

To change a title, the user selects one icon, then chooses the “Edit Properties” option from the menu. The properties dialog 180 is displayed as in FIG. 19 (or 18). The user should select the general properties option 181 in the dialog box and then enter the new title. The title is associated with the icon and will be saved to the database when the user uses the mouse to select the “save” button in the properties dialog window.

5) The information associated with an icon is always stored in the database. In addition, it is stored internally in memory in the visualization software. The visualization software implements a search routine that enables the user to search the related information in memory. The results of the search are then highlighted on the map. Thus, the user can search on the title, the URL, the notes, etc.

One extension to this method of searching is to maintain only a minimal amount of information in memory in the visualization software and to perform searches against the database.

6) The user can mark icons as “done.” When marked as done, the icon is decorated with a check mark, for example. The user can use the done mark to indicate a state of the page. The name “done” implies that the user is finished with the information presented in the page. However, because the user can set or clear the done mark, the state indicated by this mark is more clearly user-defined. For example, in the context of an on-line course where each icon represents a page of information that a student must learn, the done marker can be set after the initial read of the page. Because the done marker has a graphical representation, the student can look at the map and visually identify which pages have not yet been read. The student can also clear all the done markers when it is time to study for a test, and after reviewing the material, set the done marker again. When a user changes a done marker associated with an icon, the information is written to the database.

Now a brief explanation is provided as to how information may be added to the map. This map, initially, may be empty. In a first exemplary embodiment of the present invention, each time a web page is visited, an icon corresponding to that web page is added to the map. As web links are traversed, icons are added to the map. Furthermore, the map is updated to indicate the traversal from web page to web page by providing links between corresponding icons on the map.

A given URL is represented by at most one icon on the map. Hence if a user visits a page multiple times, there will be exactly one icon created and displayed on the map. The icon/page relationship is recognized based using two criteria: (1) the URL of the page matches the URL associated with the icon, or (2) the URL of a specially named frame in the page matches the URL associated with the icon.

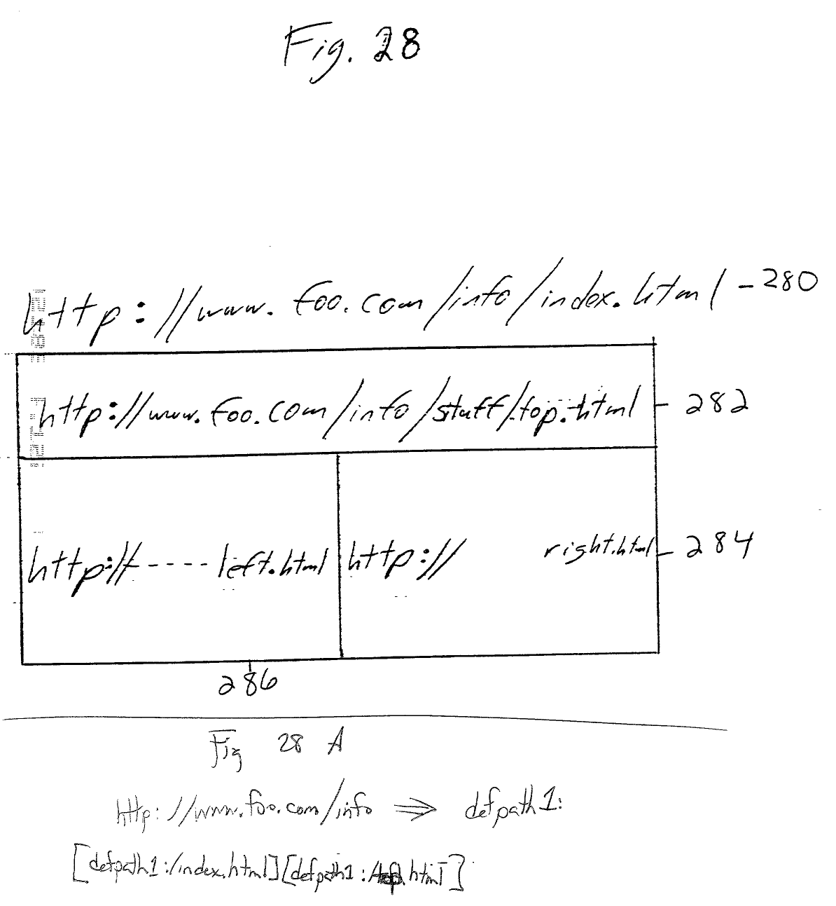

The second criterion enables an entire HTML frame hierarchy to be characterized by the contents of a single frame. This is helpful in cases where, for example, the pages in a web site are all displayed in a frame set in which the top frame contains a toolbar and the actual information is in a separate frame. This is illustrated in FIG. 29. In this example, when a user selects a link in the toolbar frame 290, the contents of the data frame 292 changes. As shown in FIG. 28, the overall URL 280, as viewed by the visualization software, is made up of the URLs of the individual frames (frame 282, frame 284 and frame 286).

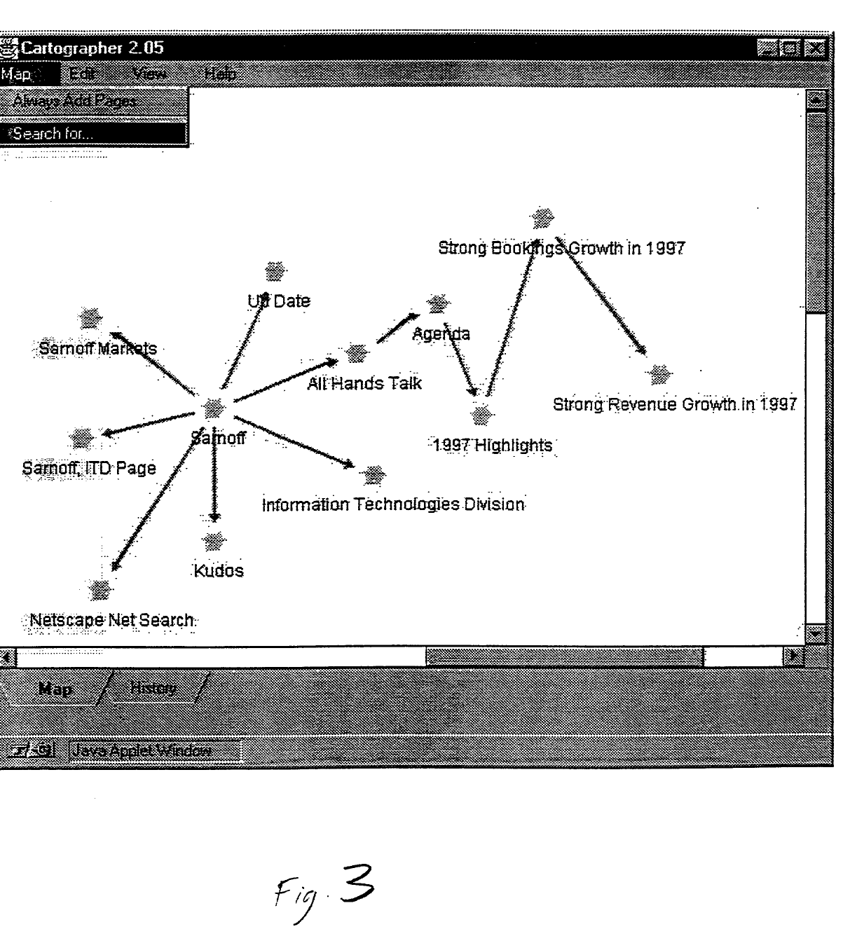

In the first exemplary embodiment described above, icons associated with pages are automatically added to the map when the corresponding pages are visited on the web. This is only one option. Another option exists where a page may be visited, but this page is not automatically added to the map. Thus, a history table is maintained. This is shown in FIG. 4. This history table shows, in chronological order (for example) the various pages which have been visited by the user regardless of whether they are on the map. Furthermore, in this history table, certain pages may be decorated to indicate whether or not corresponding icons appear on the map. This operation is illustrated as follows. If a search engine is being used, the user may not want to show the query which is used or the various hits which are obtained by the search engine if these hits are not helpful to the user. Thus, after the fact, i.e. after pages have been visited and their associated data has been placed in this history table, the user may selectively add this information to the map on an individual or group basis.

As illustrated in Table 1, each line in the history table is decorated based upon whether the corresponding URL is included in the map. An obvious extension of this is to include additional decorations based upon attributes of the node in the map, such as whether there is a note, or whether the node has been marked as “done.”

TABLE 1
How History Decoration is Determined

```
For each line in history table
If URL is in map
      Draw decorated line
Otherwise
      Draw standard line
```

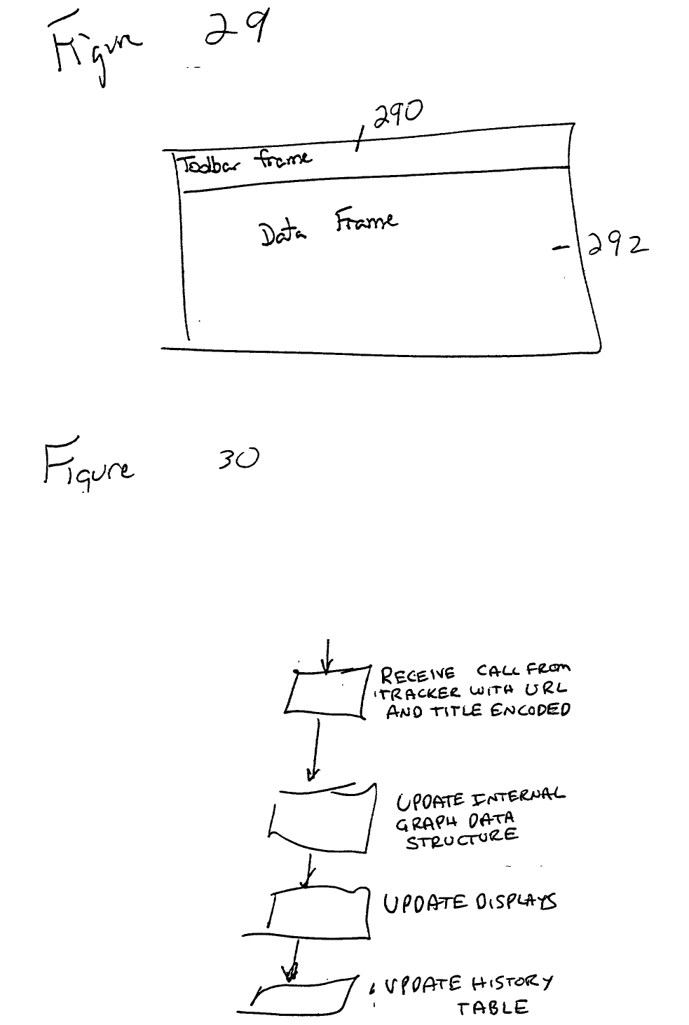

FIG. 30 and Table 1 show how the visualization software updates the map and history.

Each user may be provided with a predefined map, for example, to act as a course syllabus. This predefined map may include icons and links which may not be deleted. In the current embodiment no icons or links that are on a pre-defined map can be deleted by the user, although an obvious extension is to remove this constraint. A flag associated with the icons/links controls this property. This gives all the users a common base for their map. These icons and links may be removed from view (or hidden), but they cannot be logically deleted from the map. The icons and links added by the user, however, may be deleted as the user wishes. When nodes are removed, their children and corresponding links may be removed from view. An icon may be decorated to show that there are other icons which may be linked to that icon but which are hidden from view. The map may be displayed with or without the user's modifications.

In an alternative visualization mode, the concept of a root is important. A root icon is defined as an icon which does not have a parent. A root icon may be implicit. This means that the icon truly does not have any parents. A root icon may also be explicit. This means that the user has indicated that the icon is to be treated as a root even though, in actuality, it may have a parent. In other words, the user can specify that the icon is a root regardless of whether it indeed has parents. In this alternative visualization mode, all preceding nodes up to the root are displayed.

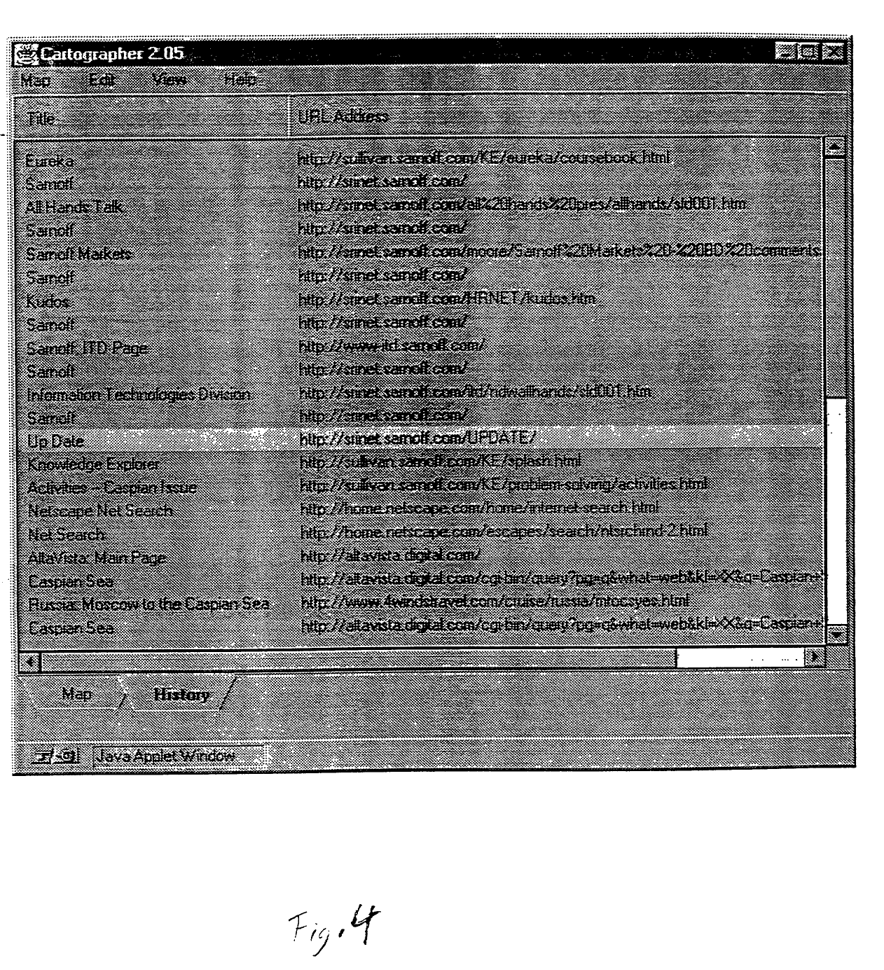

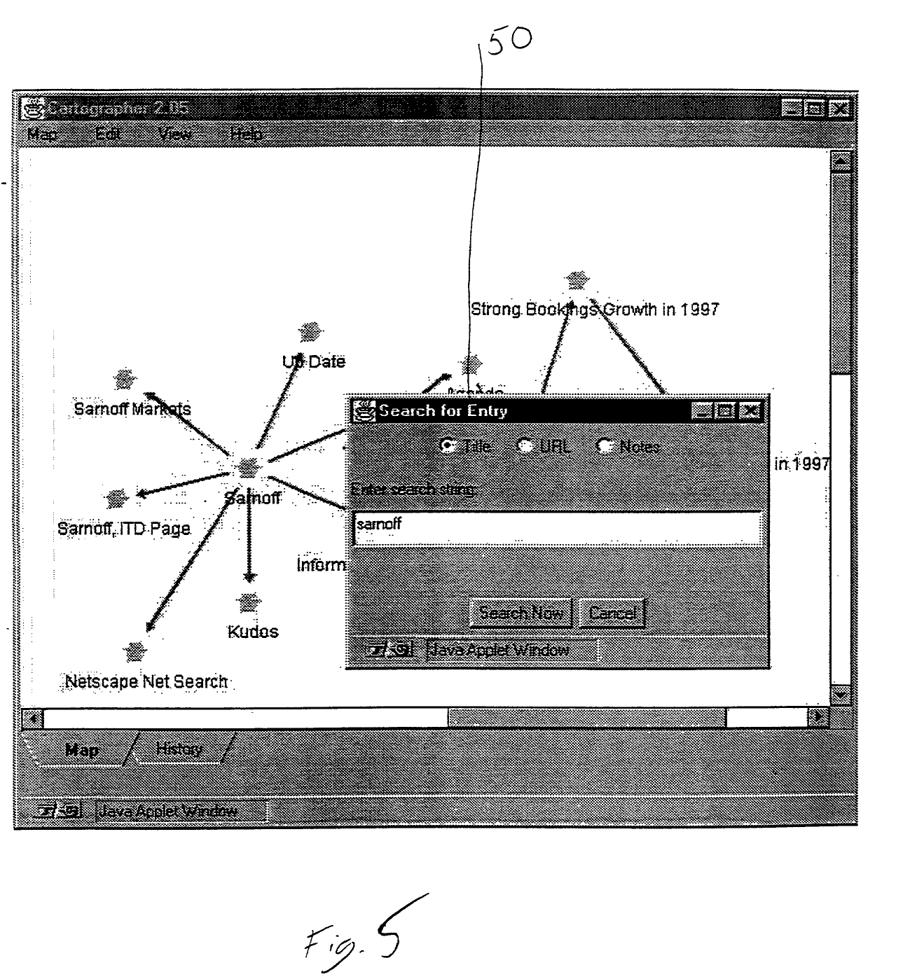

FIG. 5 illustrates a search facility in accordance with an exemplary embodiment of the present invention. When the search dialog box 50 is selected, the user may enter a search string. As shown in FIG. 6, every icon 62 which has associated data matching the search string is identified. Also, as shown in FIG. 5, it is possible to search in various fields. One exemplary field which may be searched is referred to as title. Title is a name given to an icon. Although each icon corresponds to a web page with an associated URL, a separate title may also be specified.

To specify a search, the user selects the search function from the menu. Alternative methods of invoking the function can be through the use of on-is screen buttons or mouse-based menus. The search dialog box 50 is displayed and the user can select the field to be searched and the search criteria. When the user selects the search button, the internal graph data structure representing the map is searched using standard techniques and all the nodes that match the search criteria are marked as being part of the search results.

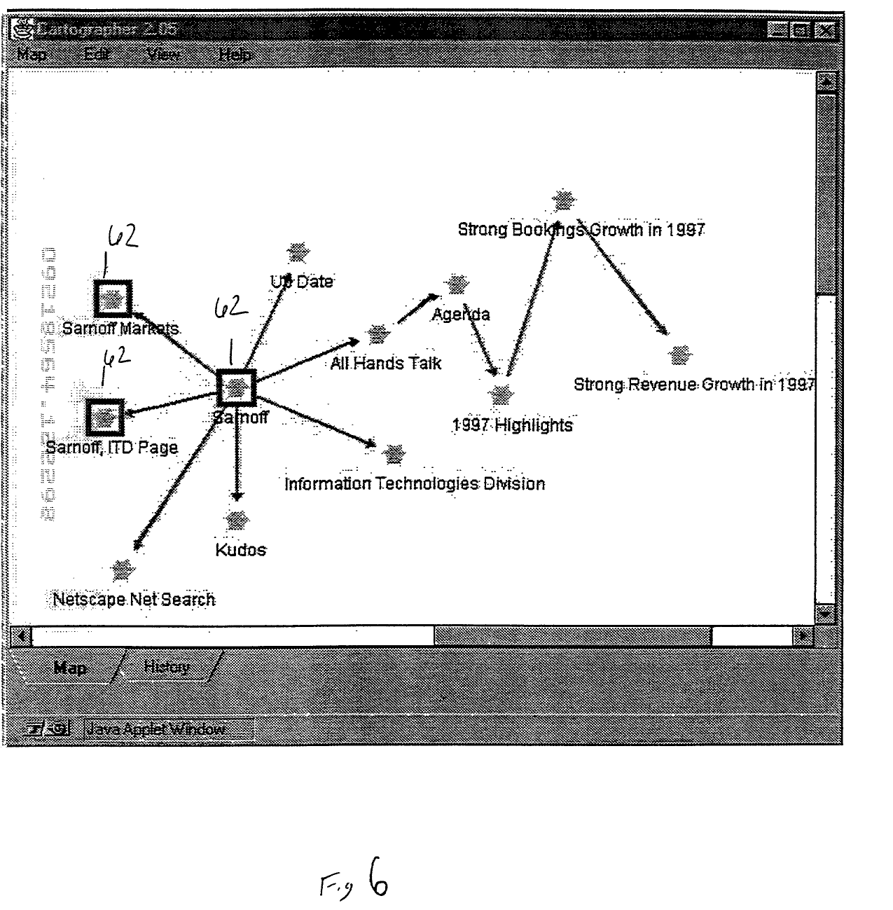

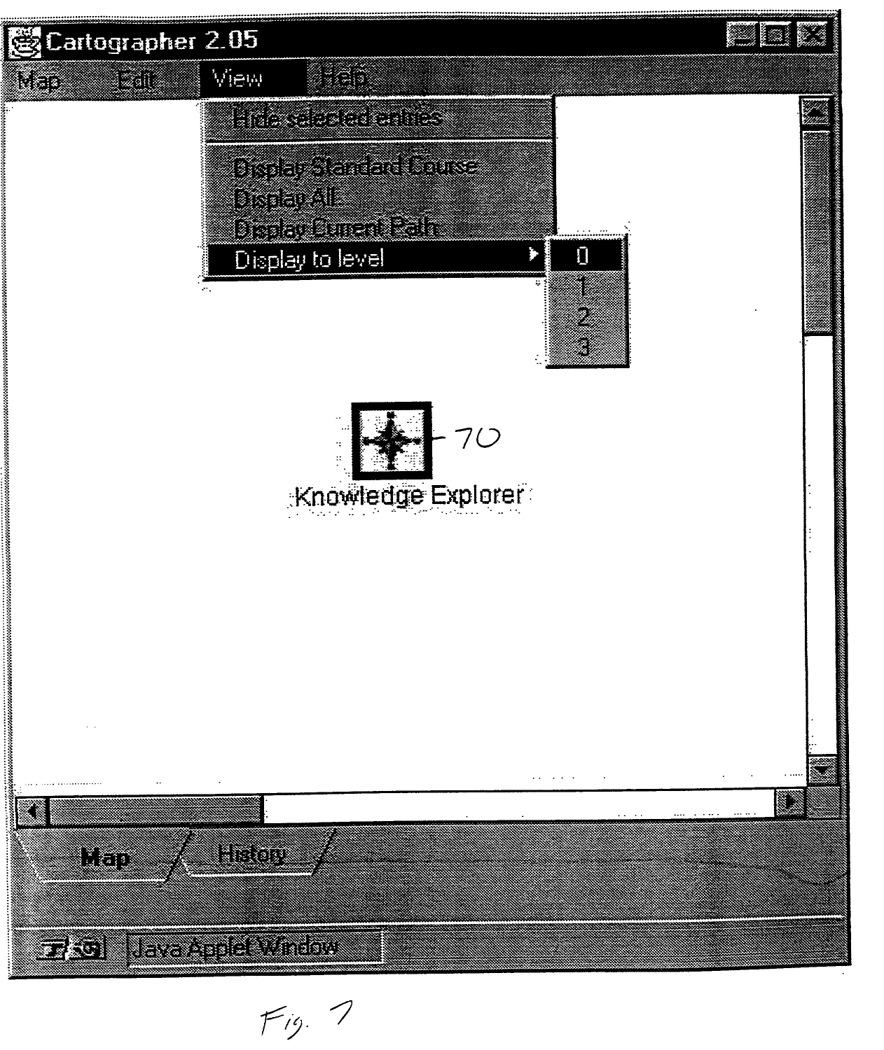

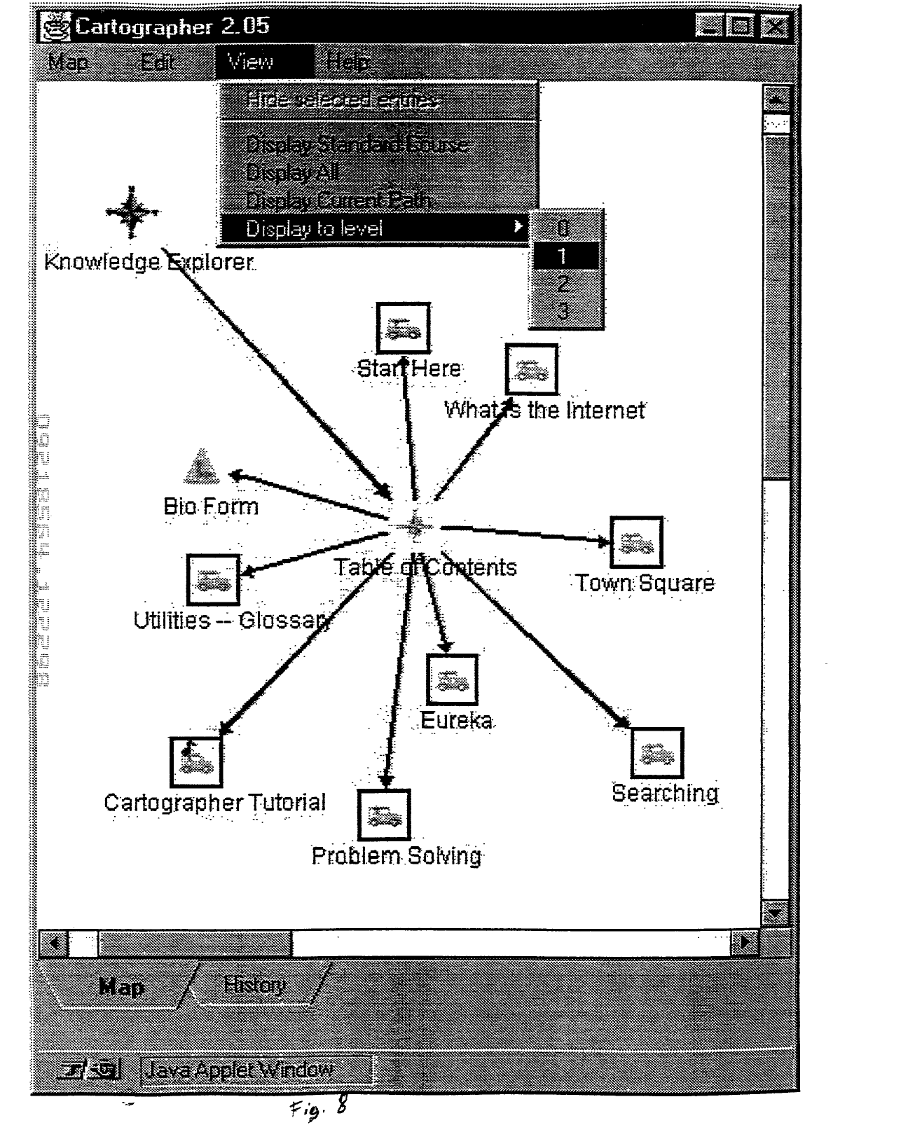

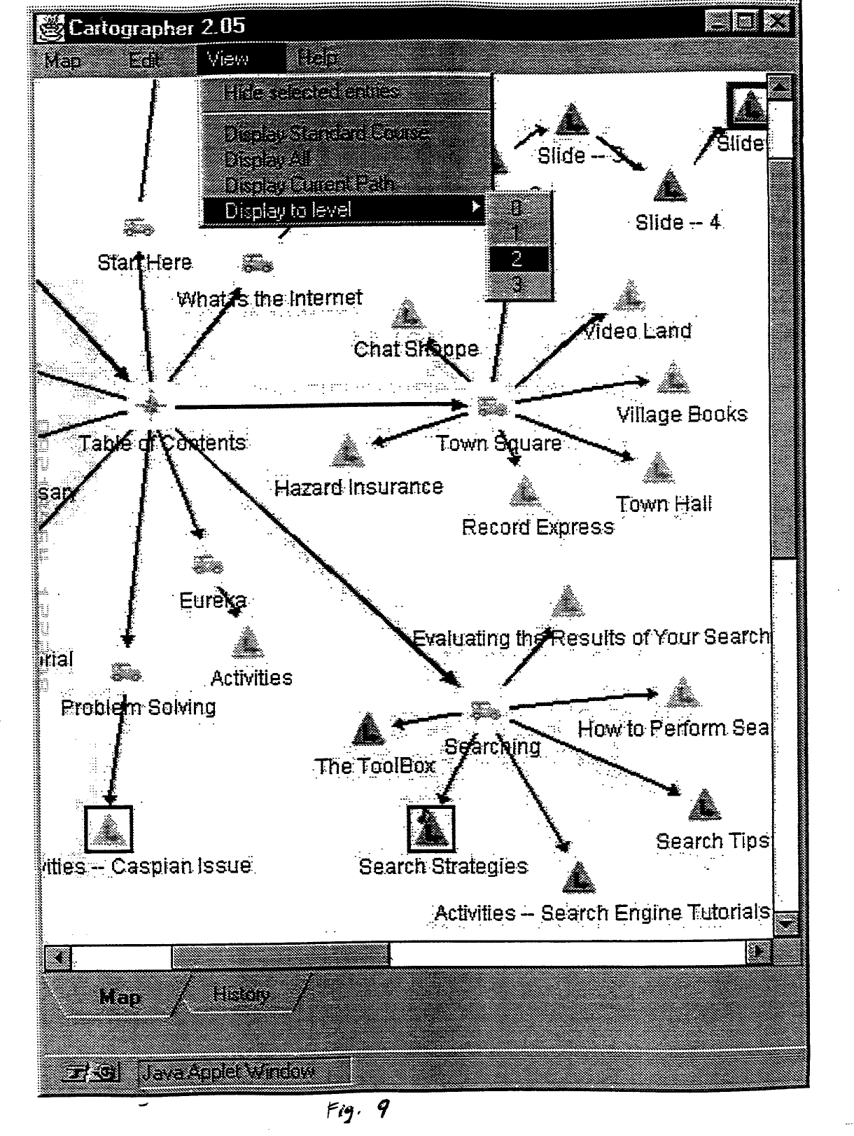

An alternative visualization mode is referred to as “display to level.” In this visualization node, notes are assigned various levels within a hierarchy. A hierarchical level may be specified. The links corresponding to this hierarchical level may then be displayed. Note that when the nodes are created, the hierarchical levels can be automatically assigned at that time. Thus, all the icons situated one link away from a designated node are referred to as being at Level 1. Icons situated two1 links away from a designated node are referred to as Level 2, etc. As shown in FIG. 7, the user has requested display from a designated node 70 to Level 0. Thus, only the designated node is displayed. In FIG. 8, the user has indicated display to Level 1. In FIG. 9, the user has indicated display to Level 2. In FIG. 10, the user has indicated display to Level 3.

When a node is visited, all children associated with that node may be displayed regardless of what was previously displayed. Thus, for example, a parent and a child may be shown with the link between the two. Initially, the child may be shown with all of its respective children hidden from view. When the child is visited in the browser, however, the child's children are automatically displayed so that further context may be provided from the user. The “current” node and its immediate children are always displayed.

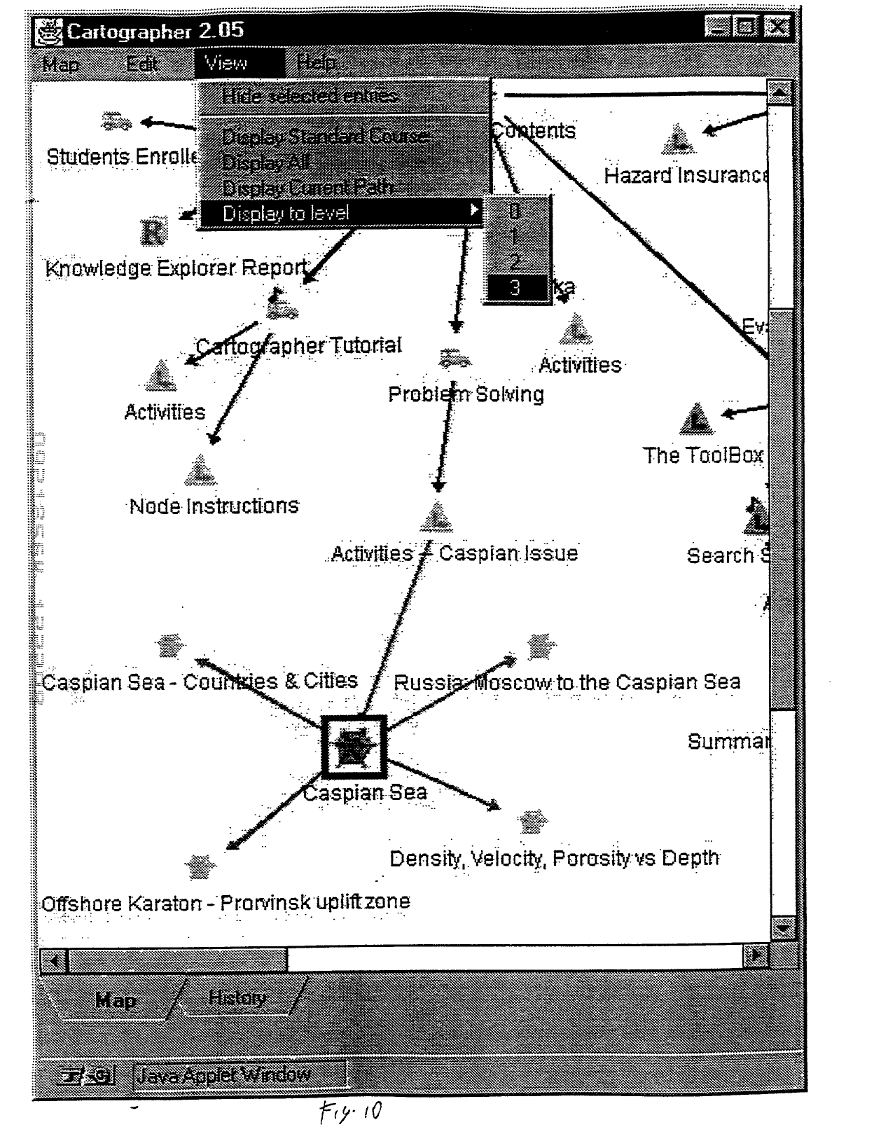

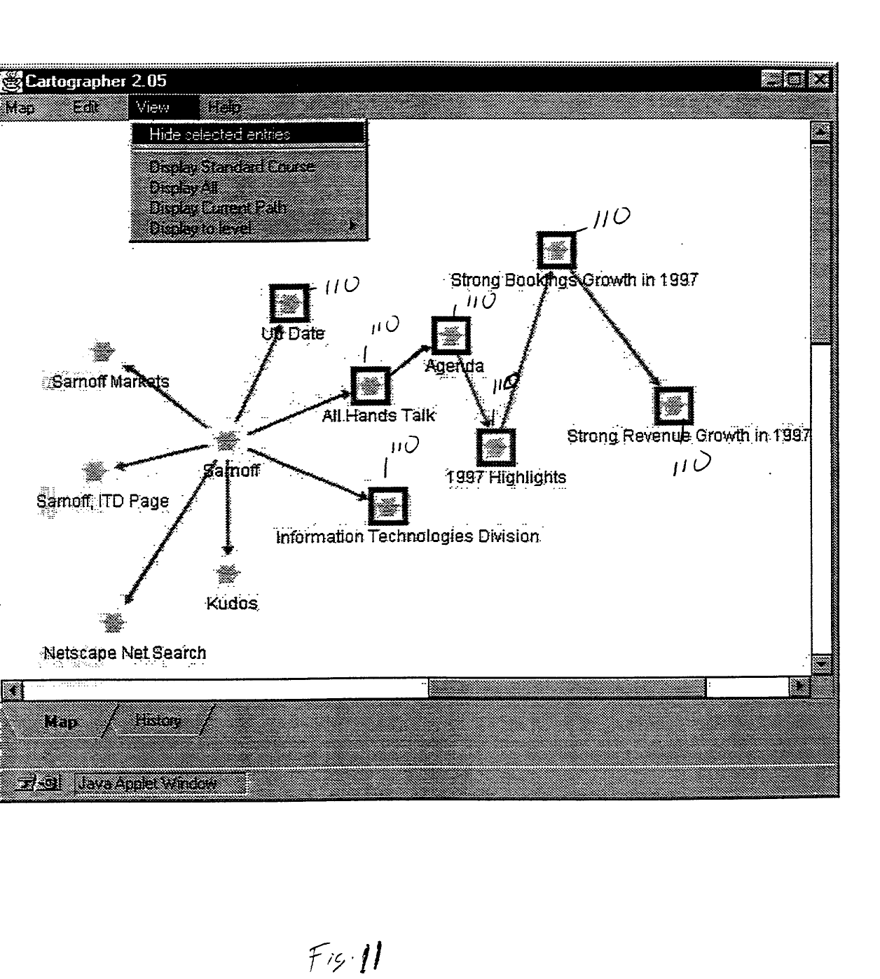

As shown in FIG. 11, the user has the option to hide individual icons. Thus, by designating certain icons 110 and selecting the Hide Selected Entries option, these icons may be hidden from view as shown in FIG. 12.

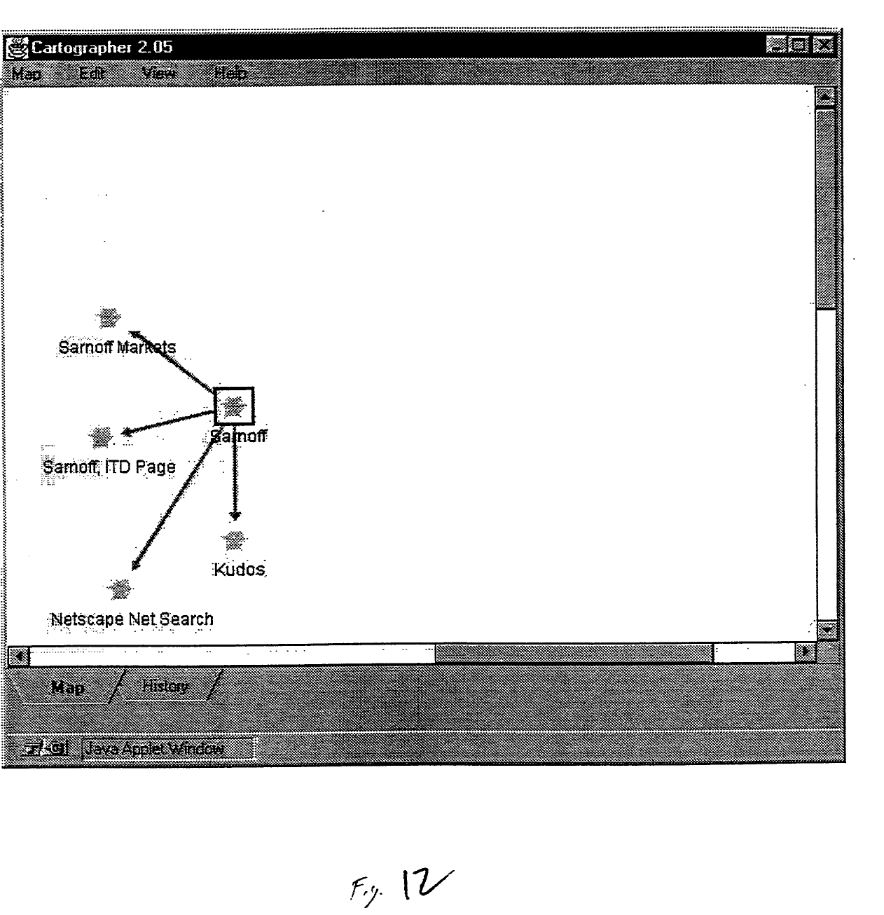

It is also possible to display only those icons which correspond to the web pages visited in the process of reaching a final web page. This is illustrated, for example, by FIG. 13. As shown in FIG. 13, icons corresponding to web pages visited prior to a current web page 130 (corresponding to the icon to the right most of the screen) are shown. The root 132 is also indicated.

The routine for displaying the map can use either a functional programming or object-oriented programming paradigm. In the functional programming paradigm, the display routine will loop through each node, examine the various attributes including position in map, whether the node has been visited, is currently visited, and whether there are notes and if indicated by the visibility attributes including level, draw the appropriately decorated icon. In the object-oriented paradigm, whenever an attribute of a node is changed, the node is automatically redrawn at that time.

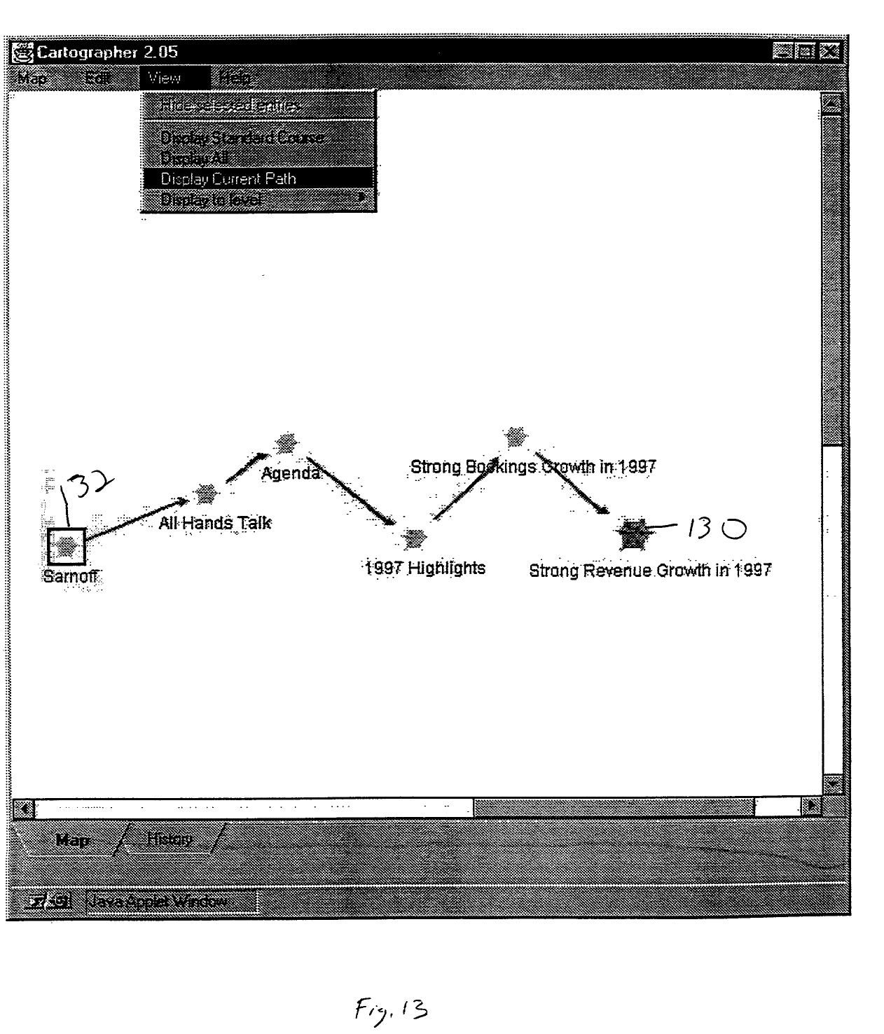

Alternatively, as shown in FIG. 14, it is possible to display all of the icons included in a map.

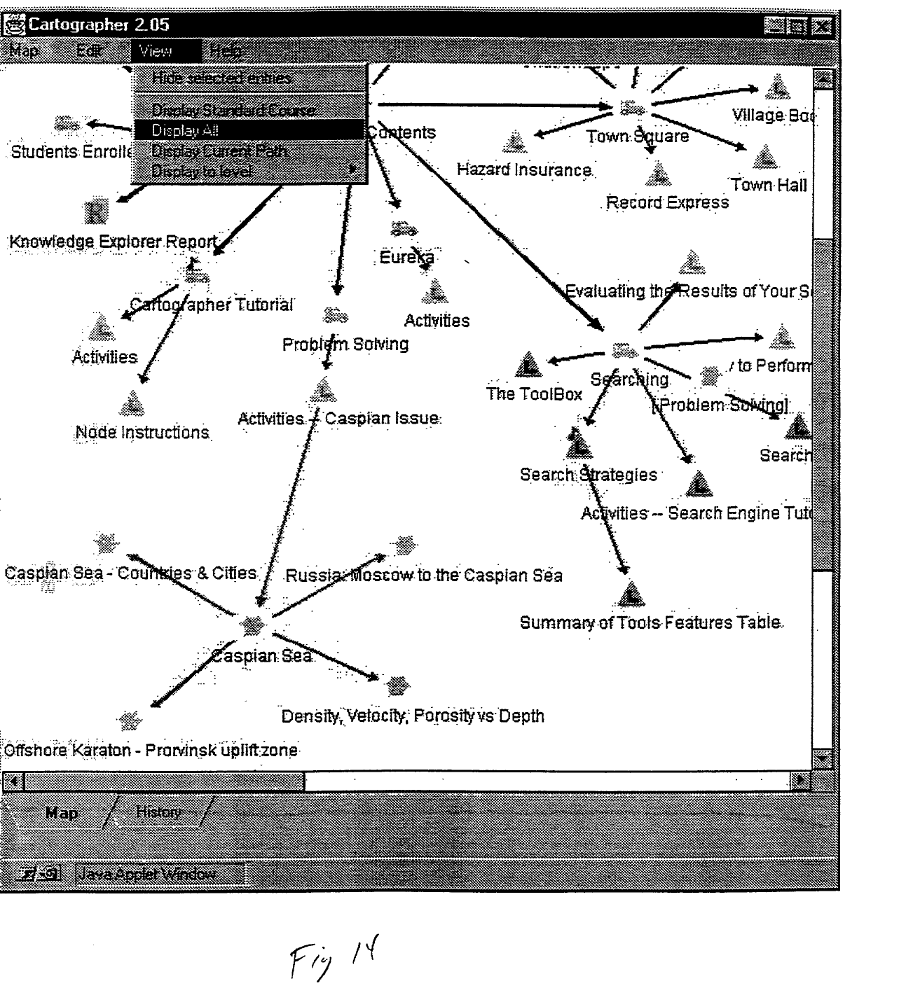

As a new web page is visited, this web page may be added to the user's map. This is illustrated, for example, by FIG. 15. The addition of a web page to the map may be initiated by the tracking portion of the client. Tracking may be implemented, for example, using JavaScript, or C++. Tracking can reside in the browser or as an external program. The purpose of tracking is to monitor what pages the person has visited. This information is then stored in a database on the server. The information stored on the database may include, for example, the URL title, the date and time of the previous access, and, optionally, the length of time the person spent viewing the page. This page may have been accessed, for example, directly from a server, or, alternatively, from the browser cache. Tracking monitors access to a page regardless of where the user is on the web. This information may be stored, for example, chronologically in the database.

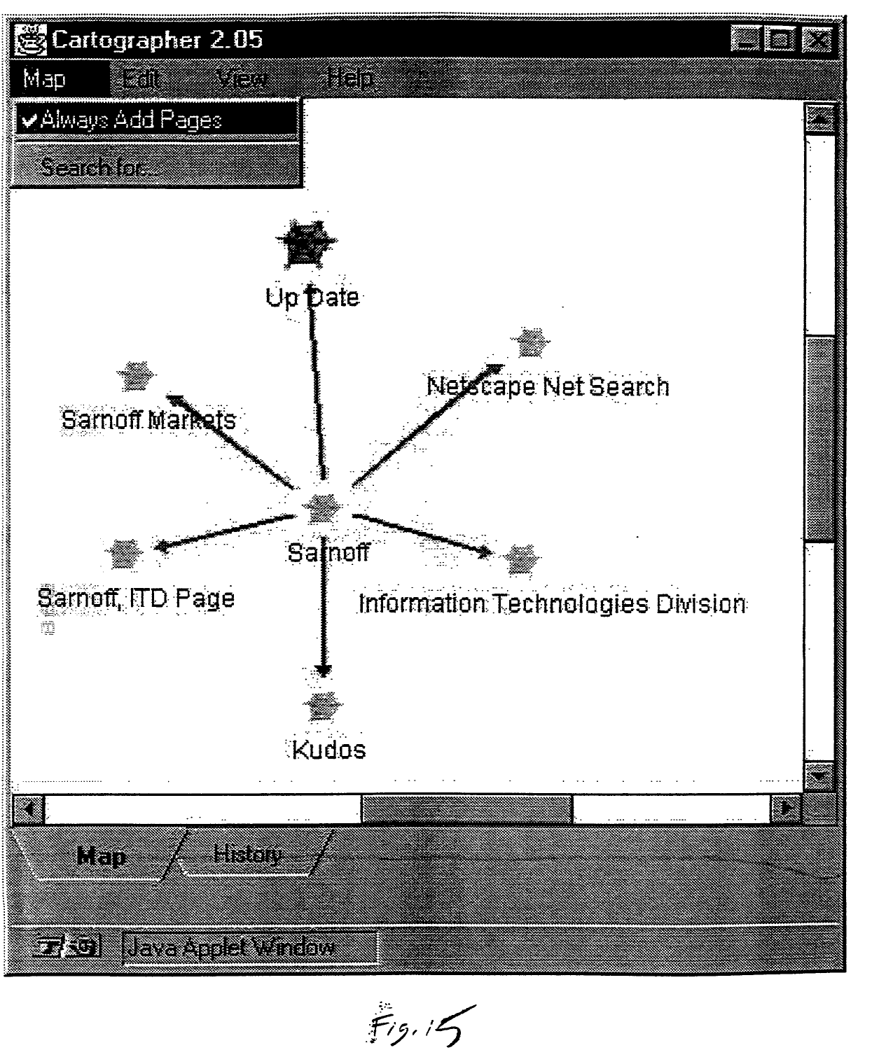

As shown in FIG. 16, each time a web page is accessed, information associated with that page may be added to the history table. Not all web pages indicated on the history table may also appear on the map. Thus, as shown in FIG. 16, a facility is available to allow a web page, which previously was only indicated by a history listing, to now appear on the map.

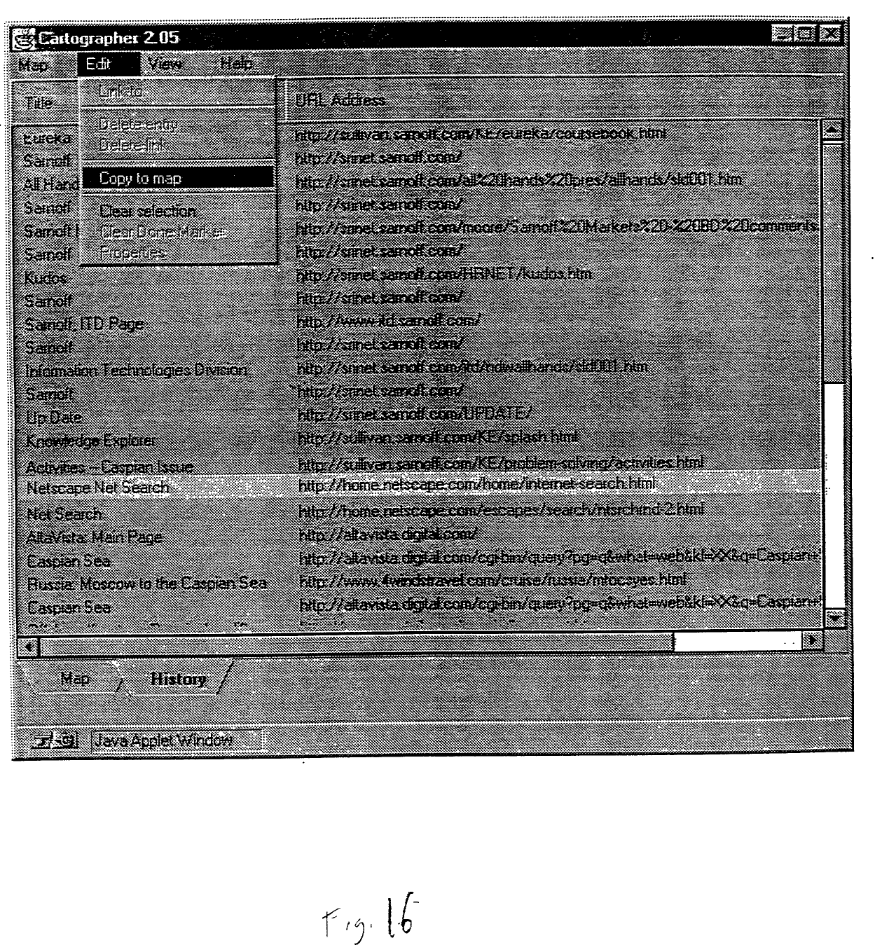

As shown in FIG. 17, each icon on the map may have associated properties. These properties may be, for example, notes, which normally do not appear when the icon is displayed. By highlighting an icon and selecting the properties feature, the notes associated with that icon may appear. These notes can be modified as desired. Furthermore, as shown in FIG. 19, there are general properties associated with each icon. These properties may be, for example, a title for the icon, chosen by the user, a URL for the web page associated with that icon, etc. The properties dialog box 180 may also indicate the hierarchical level of an icon from a root icon as well as whether the web page associated with that icon has been seen previously and whether the user has indicated that the viewing the web page associated with that icon is completed.

As previously explained, the links which appear on the map do not necessarily correspond to hyperlinks between various web pages. Thus, the user is given the option to designate a link between two icons even though there is no hyperlink linking the two web pages associated with those icons. Thus, as shown in FIG. 20, the user may select the “link to” feature in order to show a relationship between two icons.

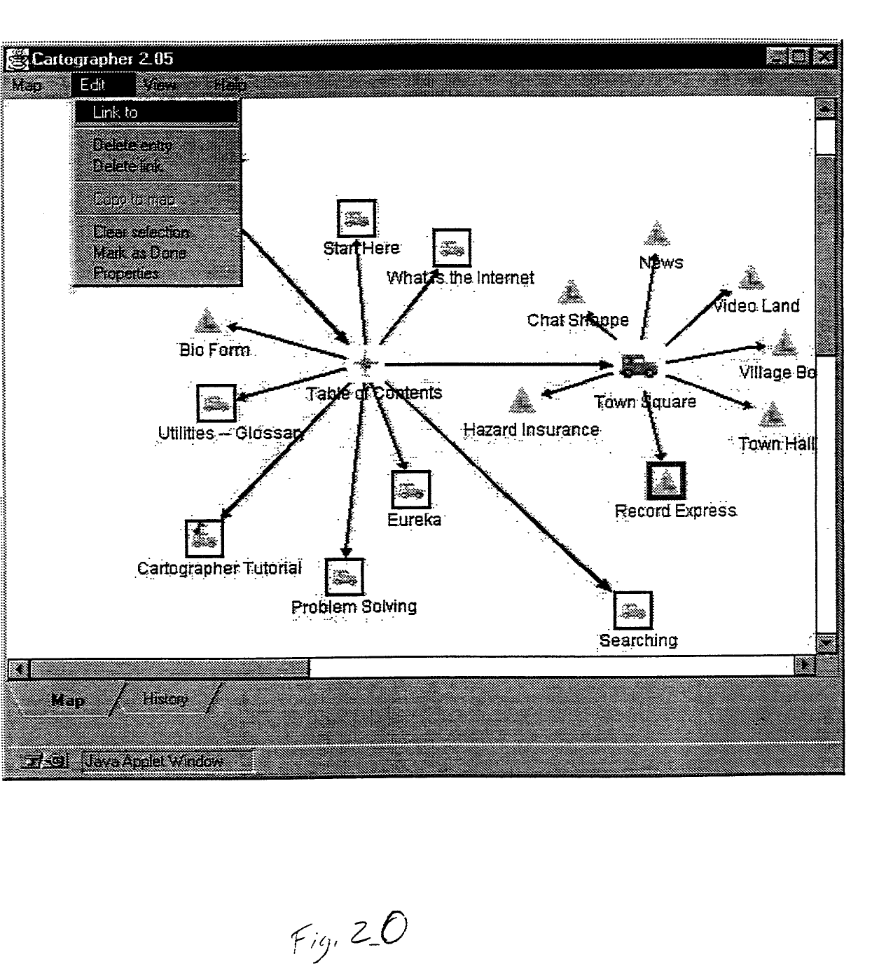

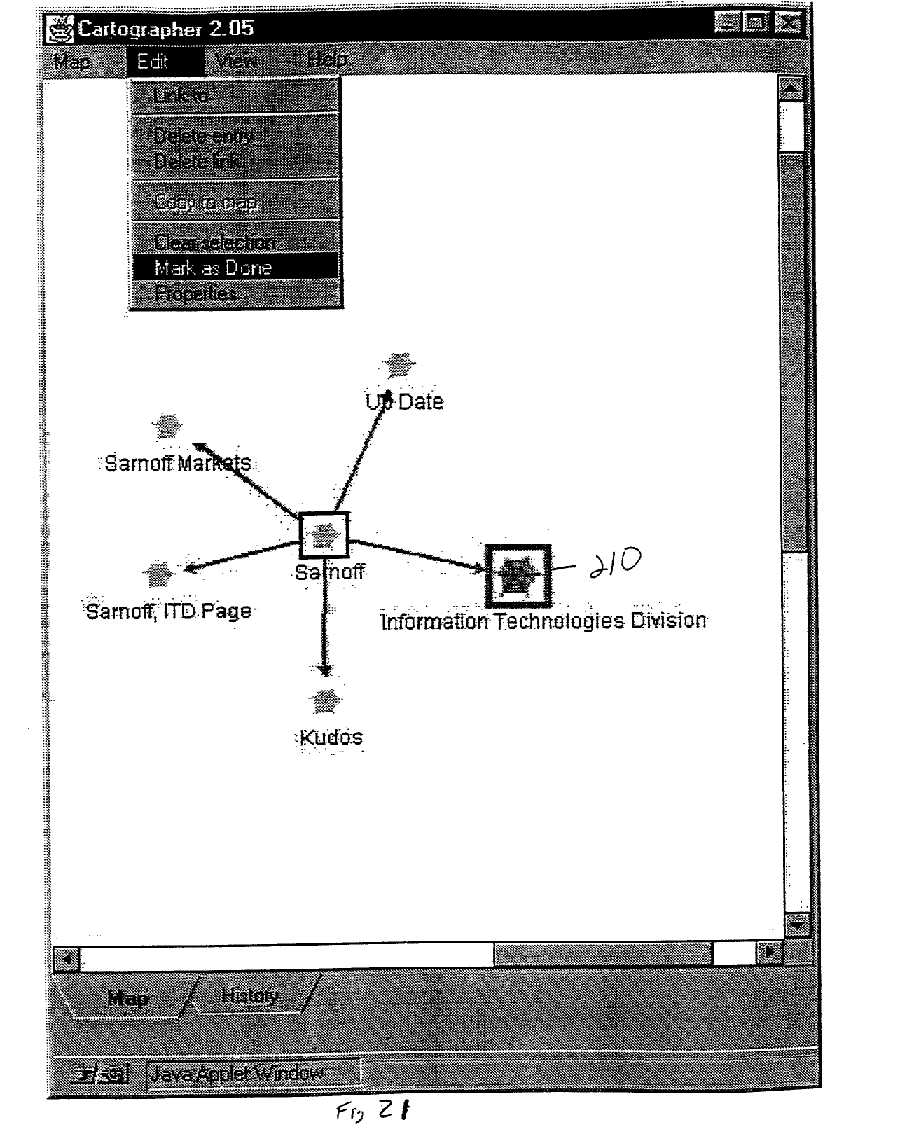

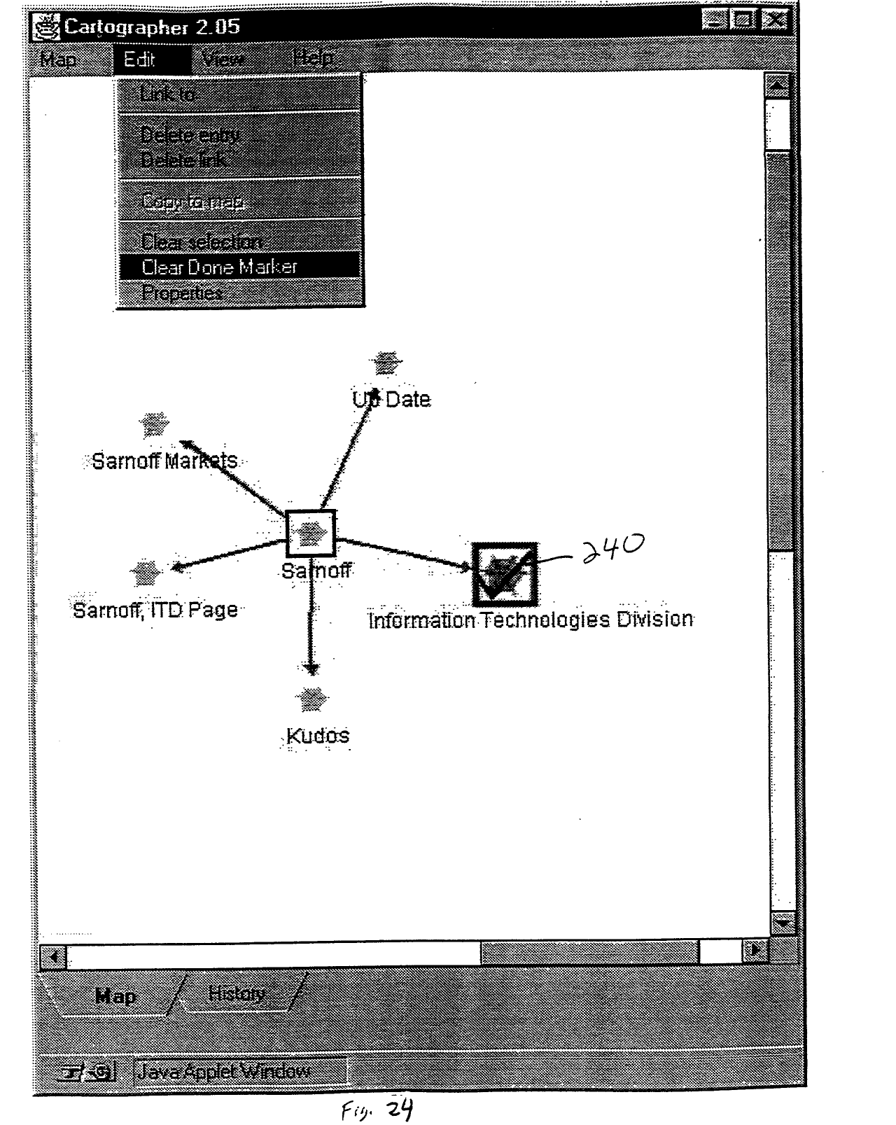

As shown in FIG. 21, and as previously described, when a user is finished viewing the web page associated with a particular icon, the user can mark that particular icon 210 as done. Furthermore, as shown in FIGS. 22 and 25, the user has the option of deleting a particular icon from a map. Again, although the icon has been deleted from the map, it still appears in the History Table. Furthermore, node deletion differs from node hiding. In node hiding, there are relationships among various icons. These icons, simply are not displayed, although the relationships still exist. By contrast, when a node is deleted, any relationship between the deleted node and any other node is also deleted.

As shown in FIG. 23, just as a node can be deleted, it is also possible to delete links between two nodes.

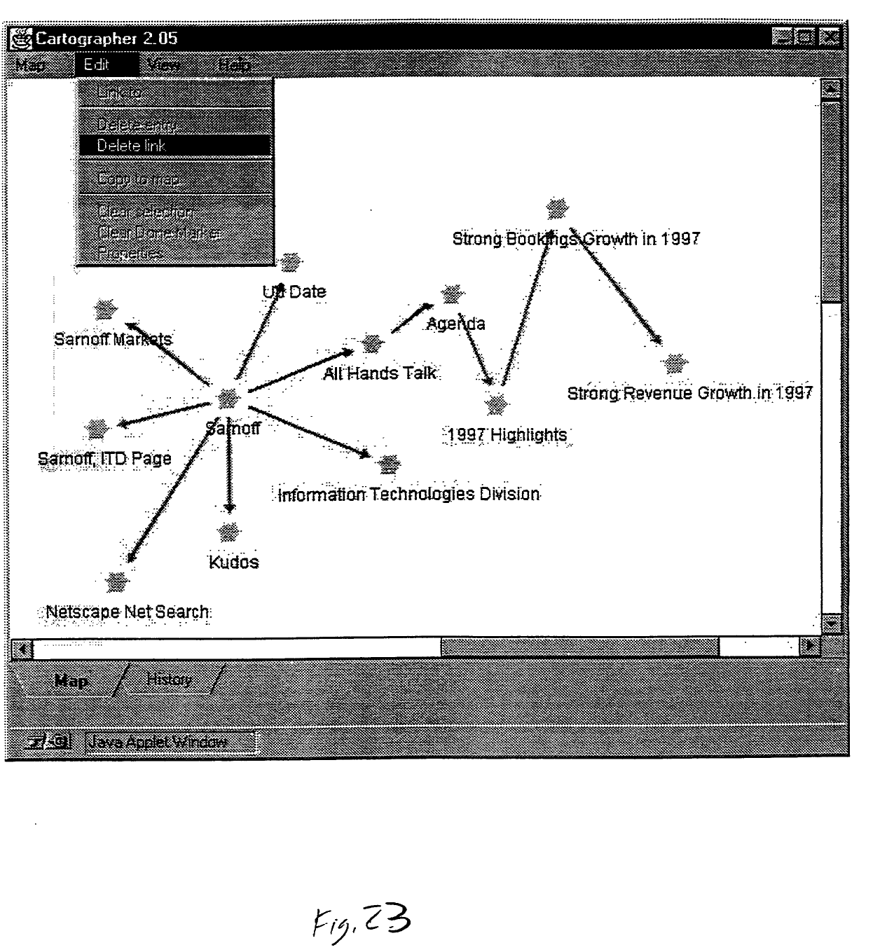

As shown in FIG. 24, and as previously described, certain nodes may be marked as done. This is accomplished with the use of a done marker 240. It is also possible to remove a done marker 240 so that the node is no longer marked as being done.

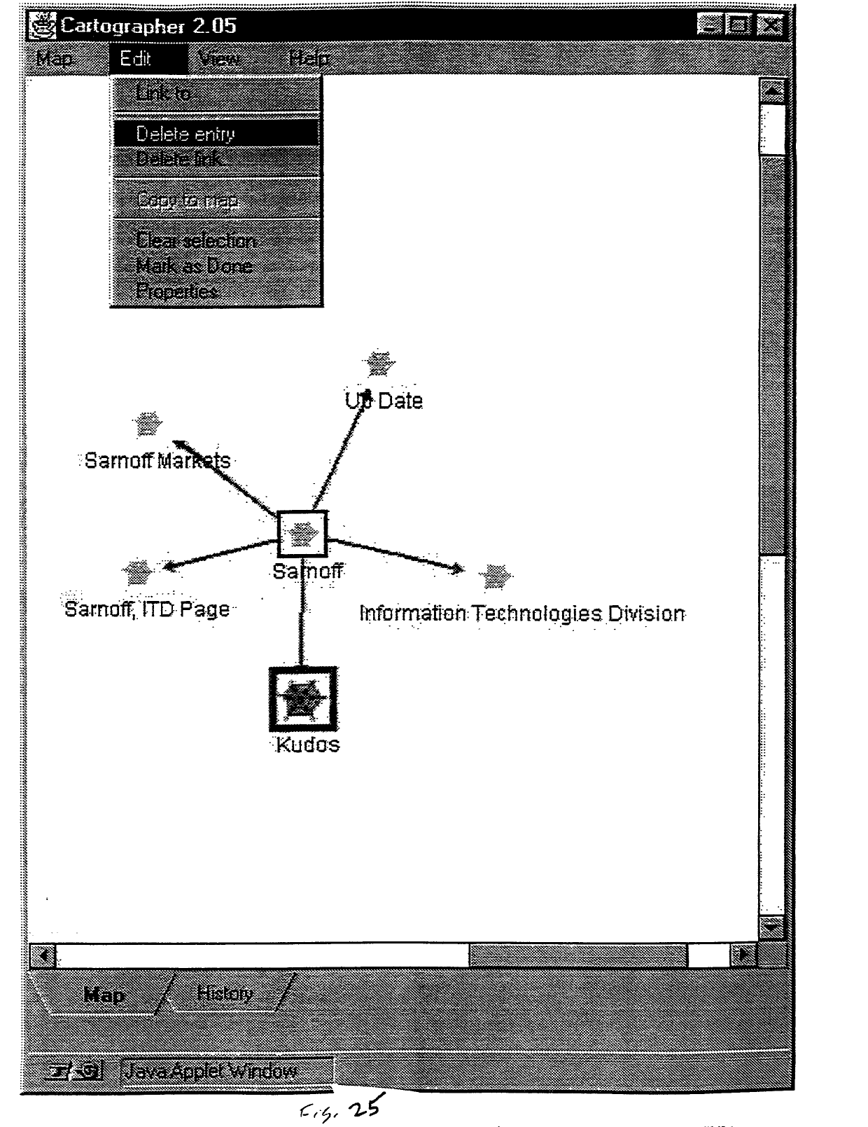

The concept of visibility sets will now be described. This description refers to FIG. 26. In FIG. 26, each circled group of nodes may be referred to as a visibility set 260. Each visibility set 260 may be identified by a unique identification number. A visibility set may be hidden until any one of its nodes is visited. When a node is visited, all nodes in its visibility set are displayed. Furthermore, nodes in a visibility set may be specified as initially visible regardless of whether any node in the set has been visited. This indicates to the user that various nodes (and their possible children) can be visited. The visibility set can be displayed in one of several ways. In the first way, if a node in the visibility set is visible through double clicking the icon, then all the nodes in the visibility set are displayed. Alternatively, if a URL corresponding to a node in a visibility set is visited through navigation in the web browser, then all the nodes in the visibility set are displayed.

One example implementation uses node attributes to indicate the visibility set and whether the node is initially visible on the map. One attribute that may be associated with every node contains a single non-zero integer value to represent a visibility set. As shown in FIG. 26, multiple nodes can and should have the same value. A second attribute associated with the node may be a primary visibility flag. If set, the node is visible (unless specifically hidden by the user) even if the other nodes in the visibility set remain hidden. The visibility attributes of the nodes in a visibility set change whenever a URL associated with a node within a visibility set is visited (as communicated by the tracking software). This function is exemplified in the pseudo-code shown in Table 2.

TABLE 2
Let U be the node corresponding to the visited URL
Let VS(U) be the visibility set attribute of U
For each node, n, in the map

If (VS(n) == VS(U))

| | |
|---|---|
| Set VS(n) to 0 | // clear the visibility set |
| Set visible(n) to true | // make visible |

Set VS(U) to 0
Set visible(U) to true

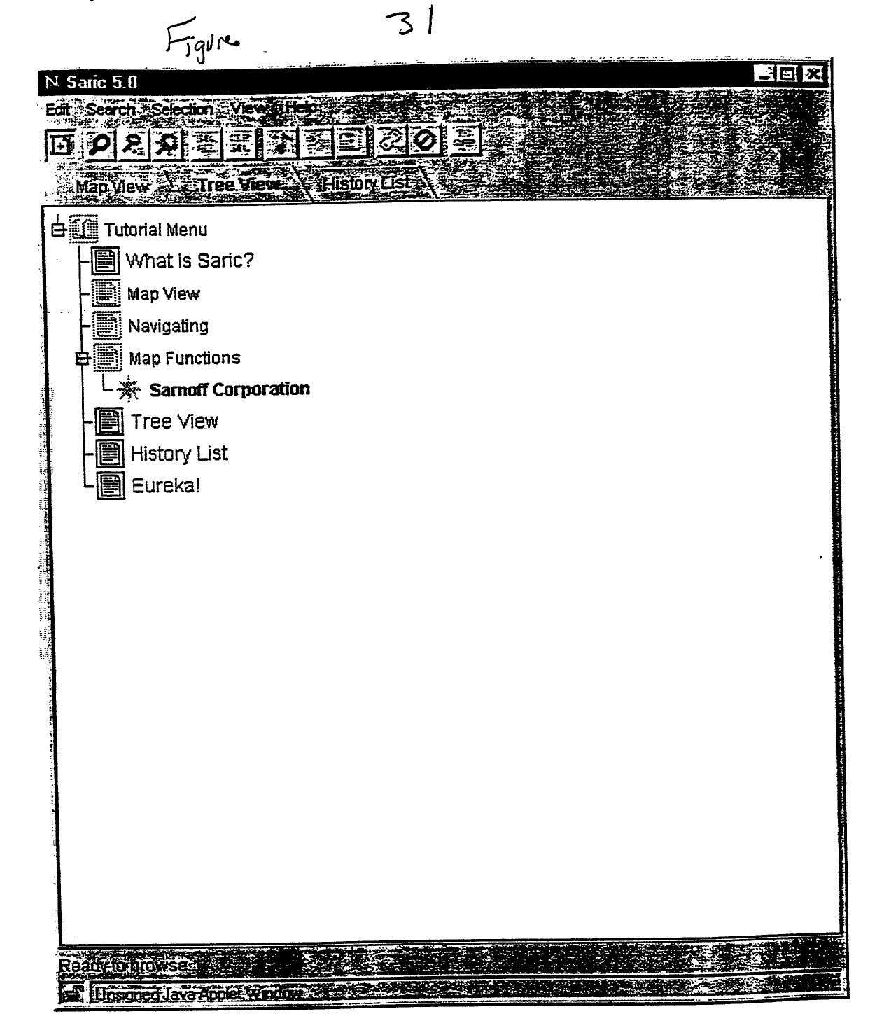

Another form of visualization, similar to the format used by Windows® Explorer, may also be used to show context (FIG. 31). In this mode, nodes can be assigned, for example, new parents, but not multiple parents.

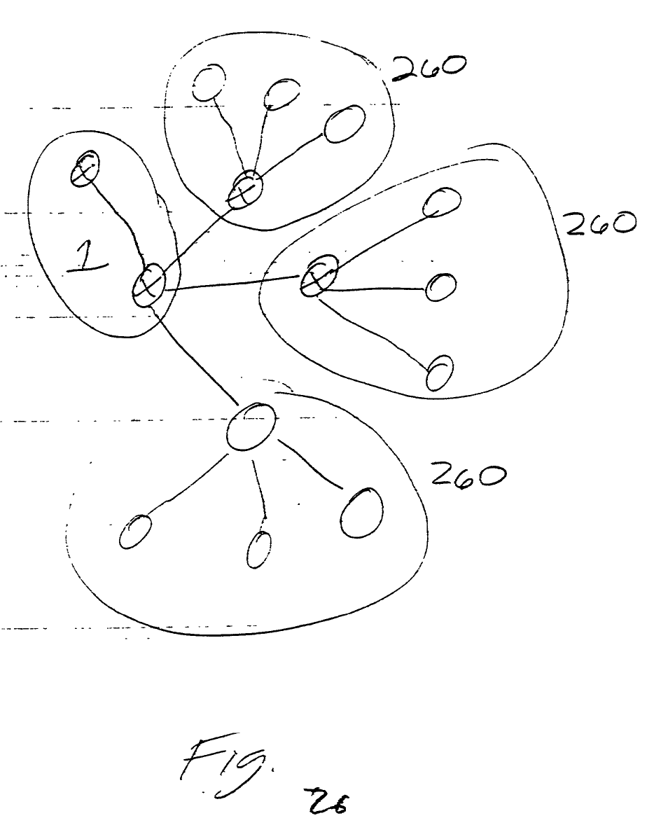

Referring to FIGS. 27A and 27B, there may be separate pages in separate browser windows 271 and 272. The links which are traversed in each browser window may be illustrated as disconnected graphs. However if a user visits a page which is already represented on the map, then a corresponding link is inserted in the map to the existing icon. So, for example, in browser window 271, pages A, B, and C are accessed in sequence. Furthermore, in browser window 272, pages X, Y, and Z are accessed in sequence. If page x is then accessed in browser window 271, the map will indicate a link 270 (i.e. line) as shown on FIG. 27C, which is drawn between the icon for page C and the icon for page X.

Regarding tracking, an optimization is possible. This is illustrated, for example, by FIG. 28. Each page 280 potentially includes a plurality of frames; each frame may be addressed by its own URL. When a page is accessed, all the frames which constitute that page are obtained. Tracking records the entire frame hierarchy. Therefore, there are several URLs which correspond to the accessed page. If tracking were to send to the server the URLs for each frame in the page, a very lengthy string of data would result. A mechanism may be available to compress the data. Thus, for example, common portions of the URLs for all the frames in the page may be substituted with a shorthand string. This shorthand string, combined with only a portion of the URL may then be used to identify all the frames in the page (FIG. 28A).

In an exemplary implementation, the database can be on a server implemented as a shared relational system, or alternatively may be stored in files on the local computer. The local file(s) could be sharable among several users.

An exemplary implementation using sharable local files could use different access paradigms. The implementation can use file locking to prevent simultaneous update of a shared map. Alternatively, data sharing can be implemented using explicit commands from the user to export and import map data. In this manner, a form of user-controlled token-passing can be used to serialize concurrent updates to a common map.

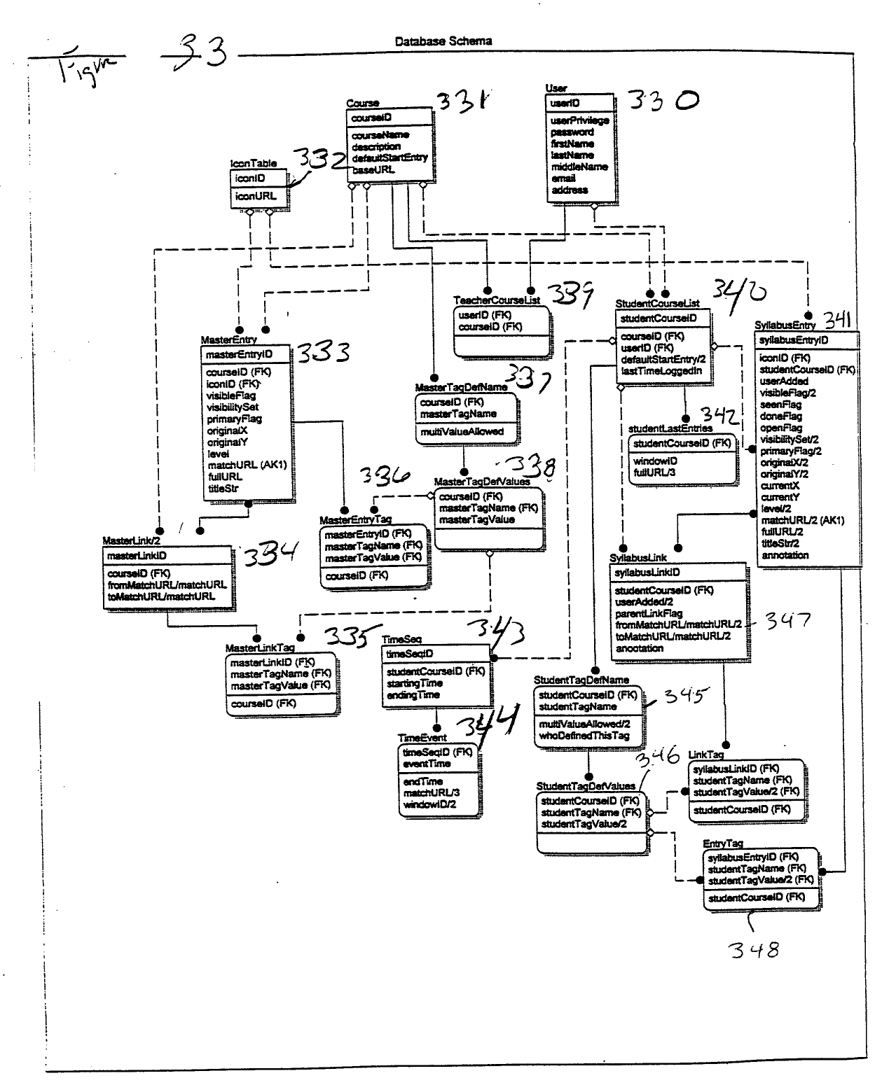

The subject invention has been described as it may be used in a university environment. The exemplary map shows courses which may be taken by students. Each course is represented in the map by an icon which points to a syllabus. In an exemplary embodiment of the present invention, twenty (20) tables may be used. The database schema for this exemplary embodiment is shown in FIG. 33. These tables may be organized as follows. First, seven (7) tables may be used which correspond to the base map. This is also referred to as the master. This is the map which is furnished to a student before modifications are made. This is the general map which is associated with a course. Thus, this general map has not been modified by any students. Each of these seven (7) tables is described below. Next, nine (9) tables are furnished for the modified (or student) map. These are the tables associated with the modified map, in other words, after the space map is viewed by a student, the space map may be modified. These nine (9) tables respond to the modified map. A system overview table is included. Two course roster tables are included. To understand these tables, each student and each teacher are referred to as users. Each user has a unique serial number. Furthermore, each course has a unique serial number. The first table shows the relationship between students and courses. The second table shows the relationship between teachers and courses. Thus, for each table, courses can be identified for an individual student and courses can be identified for an individual teacher. In addition, students and a teacher may be identified for an individual course. Two tables are also included for bookkeeping purposes. The first table may include a request for course enrollment from a current student. The second table may include a request for enrollment (i.e., into the school) from a prospective is student. Each of these tables is described in turn below.

Referring again to the base map, there are seven tables. These seven tables are as follows:

The first table corresponding to the base map is referred to as the Course Table 331. This table includes a course identification number, a course name, a description, default Start Entry (the first page that should come up the first time taking a course) and base URL (a long string which is mapped to a short string (FIG. 28A).

The second table is referred to as Table Shared Icon 332. Icon URL refers to the file name of the graphic image. This file name is used by, for example, Java so that this graphical image can be displayed on the map. The Icon ID is also included. Icon ID references an Icon which appears on the map. Each icon has a unique Icon ID.

The third table is the Master Entry Table 333. Each row in the table stores information regarding one node on the course map. This information may include, for example, the Course ID. The Course ID is an identification number unique to the individual course. A Visible Flag indicates whether the node is initially visible or not. The field Visibility Set indicates the visibility sets described with reference to FIG. 26. The field Primary Flag refers to the nodes marked with a “X” in FIG. 26 (i.e., whether the node is initially visible). Icon ID is reference to the Shared Icon Table. Original X and original Y indicate the initial position of an icon on the map. Level refers to the hierarchical level previously described. Field Sibling Order (not shown), refers to the embodiment corresponding to Windows Explorer which is described above. Master Entry ID is a unique identification number for each node. Field Parent ID (not shown), indicates the parent of each node. Title String is the title underneath a node. Full URL refers to the full reference of the URL, including the individual frame reference described above with reference to FIG. 28. Match URL is used to keep track of the current node. Match URL refers to a frame, as opposed to a page. If a page is composed of only one frame, then Match URL refers to the URL for the whole page. If the page is comprised of multiple frames, then Match URL refers to one individual frame which is used in determining whether the page which is open in the browser matches a current node on the map.

The fourth table is referred to as the Master Link/2 Table 334. The Master Link Table includes four fields. Course ID refers to the course identification for a course. From Match URL refers to the predecessor node on the map. Similarly, To Match URL refers to the successive node on the map.

The fifth table which is used is called MasterTagDefName 337. Master Tag Name includes three fields. Course ID, again, refers to a unique identification number for a course. Master Tag Name is the attribute name. This corresponds to an alternative embodiment of the present invention. In this alternative embodiment, instead of assigning individual nodes to a particular node, attributes may be assigned to a particular node. These attributes may provide a variety of predefined categories. Various values may be defined with regard to each of these categories (e.g., hair color, eye color, gender, etc.). Thus, Master Tag Name defines various attributes which may be associated with an individual icon. Multi-Value Allowed indicates whether an attribute is identified by binary identification. The field, Who Can Change value (not shown), indicates whether the user has permission to modify the attribute associated with a particular icon.

The sixth table is the table MasterTagDefValues 338. Table MasterTagDefValues defines the allowed value for a particular attribute defined with the MasterTagDefName Table. In this exemplary embodiment, two fields, Course ID and Master Tag Name, are used to uniquely identify an attribute to a course.

The seventh table which is the MasterEntryTag 336. The MasterEntryTag Table is used for the purpose of the attribute for a specific course. Thus, Tables MasterTagDefName and MasterTagDefValues are used for attribute definition. The Master Tag Table is used for associating a specific attribute value with a specific attribute name.

As will be understood by one of ordinary skill in the art, there are multiple ways to organize the various tables. For example, in one exemplary embodiment, List of Users may be grouped with List of Courses, the Rosters (i.e., the students in each course and the teachers associated with each course).

The eighth table is the User Table 330. User ID may be a log in ID. User Privilege refers to user rights (password). Fields for other unique identification is also supplied.

A ninth table, New User Request (not shown), may also be provided. Again, this table is for prospective students wishing to enroll. This individual is given a unique identification number (UserID), user privileges indicating the user rights, a unique password, and unique identification information.

The tenth table which is provided is the Student Course List Table 340. This table provides fields for unique identification numbers associated with each student, each course, each student within a course, each user, etc. A Default Start Entry Field is also included. This Default Start Entry Field is the first page which the user should see the first time he logs into the browser (only the first time he logs in).

A Teacher Course List Table 339 is also included as the eleventh table. This table is a list of all the teachers.

Table Syllabus Entry 341, the twelfth table, is also included. Table Syllabus Entry shares similarities with Table Master Entry. Upon initial use, the corresponding fields from Master Entry are simply copied into the corresponding fields of Syllabus Entry. Additional fields are also included in Table Syllabus Entry. These fields are as follows. Syllabus Entry ID is a unique identifier for the node which is in the student map. Student Course ID is an optimization which is used to identify the student within a course (as opposed to the student by himself). User Added indicates whether the information for that node was copied from the Master Entry Table or whether it was created by the visualization software for the student's particular use. Seen Flag indicates whether a user has visited the page. Done Flag is a further attribute. This attribute may be used to mark an icon as “done” by a student. This may be visually displayed. Thus, if a student wishes to indicate that he has completed his review associated with that particular icon, the user may insert an appropriate graphical decoration. Current X and Current Y indicates the current position of the icon on the map. Annotation Character String which indicates the nodes that a user is permitted to enter and which become associated with that icon.

The thirteenth table is Student Last Entries 342. When a student begins a new session, the pages which were previously opened are again opened for the user's convenience. This table is used to store those pages which were opened at the time the previous session terminated.

The fourteenth table is Table Syllabus Link 347. As its name implies, this table is used for creating syllabus links between nodes which do not appear in the base course. Entries in the Syllabus Link table are copied from the Master Link Table when a student is enrolled in the course. Thus, syllabus links may be created by the user using the visualization tool. When a student is enrolled, master links may be copied to syllabus links. Alternatively, a user may specify syllabuslinks as he desires. It is noted that during visualization, user added links may be displayed using a different color than is used to display the links which have been copied form the Master Link Table to the Extra Link Table.

The fifteenth table is StudentTagDefName 345. This is copied from Master Tag Name.

The sixteenth table is StudentTagDefValues 346. This is copied from Master All Values.

The seventeenth table is EntryTag 348. This is initially copied from MasterEntryTag. The student can modify these values as desired.

The eighteenth table is Time Seq 343 (Time Sequence). This table is used for tracking data, to identify each session during which the user is viewing a map. Appropriate fields are included.

The nineteenth table is Time Event 344. A sequence is a session. Within each sequence, identification of each page viewed by the student is captured. Also, the time when the page was loaded, the time when the page was unloaded, the window and an identification of the page are captured.

A variety of procedures are used for initializing and manipulating the tables. These procedures and their functional relationship are shown in Table 3.

TABLE 3
Table of stored database procedures that operate on tables in the database.

| Procedure | User Action |
|---|---|
| AddNode | create a new node on the map (either automatically or |
| | by copying from history table) |
| UpdateNode | change an attribute of a node (including title, |
| | position, visited, done) |
| DeleteNode | delete a node |
| CreateArc | create a new link (either automatically or manually |
| | through menu item) |
| DeleteArc | delete a link |
| ResumeCourse | log in |
| AddLastEntry | alternative implementations can have it on log out |
| | or on every page visit |
| AddEvent | visit a page |
| CopyCourse | enroll in a new course (i.e. get access to a new map) |

Procedure Add Node is used to create a new node. Procedure Update Node modifies an existing node. Also a procedure is provided for to updating a syllabus entry. Update Node and Add Node are performed by performing modifications to syllabus entries. Procedure Create Arc and Delete Arc are included for modifying the Extra Link Table. A procedure called Resume Course may be included. This procedure is used to indicate the start of a new session. This operates on the Time Seq Table. Procedure Add Last Entry is used when a user logs off of a course. This procedure is used to update the window configuration. Procedure Add Event is used to log a page visit. Procedure Copy Course is used to enroll a student in a course. In other words, this procedure copies data from the Master Entry Table to the Syllabus Entry Table and from the Master Link/2 Table to the SyllabusLink Table.

The information described above refers to the database which may be used for practicing an exemplary embodiment of the present invention.

In an alternative aspect of the present invention, a plurality of nodes to be updated may be transmitted from the client to the web server at one time. The web server may then begin to request modifications for each of these nodes in the database. Assume, subsequently, that one of those nodes is again updated. The fact that this update has occurred is transmitted from a client to the web server. In the alternative embodiment, only the successive update of the node is processed. The previous update of the node is not processed.

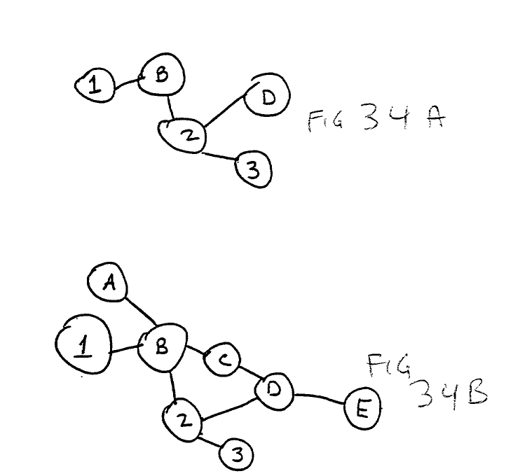

In one embodiment of the invention, a URL that is not represented by a node on the map appears on the history screen. The user can create a node on the map by copying the URL information. The software must then determine where to position the new node on the map. One placement algorithm utilizes a nearest neighbor algorithm using the set of URLs to be copied to the map. For example, suppose five URLs (called A, B, C, D, E) are to be copied to the map from the history table, and two of them, B and D, are already represented on the map. Those two nodes represent positioning anchor points for the remaining URLs. Using these anchor points, the node for URL A will be placed in proximity to the node for URL B. The node for URL C will be placed between the nodes for URL B and D. The node for URL E will be placed in proximity to the node for URL D. This is illustrated in FIG. 34. An alternative placement algorithm could also slightly shift existing nodes to make room for the new nodes.

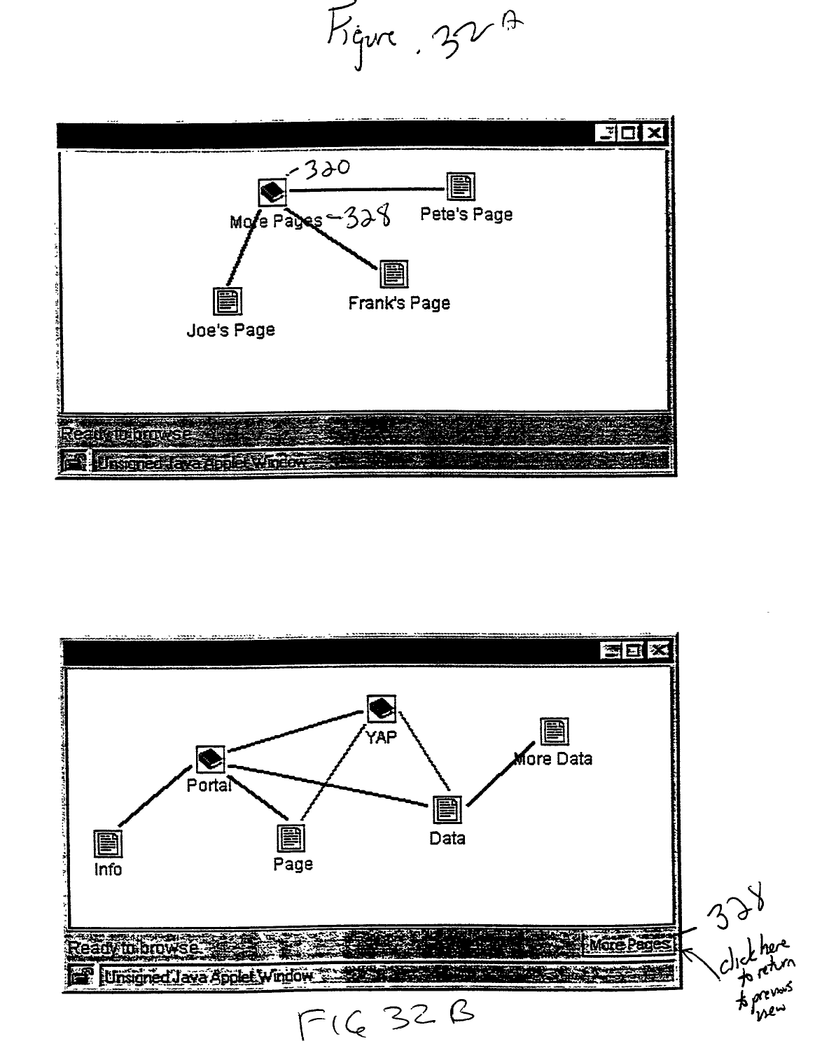

An alternative visualization technique treats each node both as a page and a possible gateway to an entirely new map. With this technique, the map space is considered to be multi-dimensional with each node being a “portal” to a different dimension. Initially, only a single dimension is shown and as the user traverses “dimensions”, the new map can be opened in a separate visualization window or in the existing window. With this technique, links can be added across “dimensions” and new dimensions can be opened automatically as the user navigates. FIG. 32 shows an example layout of a multi-dimensional map. In that map, each node contains an additional attribute that indicates where in the hierarchy the node resides. Additionally, a new data type is associated with the node. Instead of a node referencing only a URL, a node can reference a different data type, in this case, another map. With these two modifications, user commands can operate on a single dimension (the dimension currently displayed), or by allowing the user to name levels, user commands can operate across the dimensions.

In FIG. 32, the portal nodes 320 are indicated using a specific icon. For URL nodes, when the node is double-clicked, the corresponding URL is visited in the browser. For “portal” nodes 320, when the node is double-clicked, the new map is opened, in this example in the same window, and the dimension name 328 is indicated at the bottom of the window to allow the user to exit the portal and return to the previous view.

A visual cue to the different dimensions can be provided using background colors or images, or alternatively listing the dimension name in the window title.

An alternative visualization technique allows for dynamic decorations to be used on icons. The decorations used may be determined based upon user entered tags (attribute/values).

The explanation set forth is with regards to a course. It is understood, however, that a course is only one exemplary embodiment of the present invention. The present invention can be applied to any situation where various nodes are traversed. Thus, the present invention can relate, for example, to the World Wide Web, as well as other Internet and Intranet applications.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A method for indicating to a plurality of users, relationships among a plurality of accessible materials, said method comprising the steps of:
displaying a plurality of icons, each corresponding to a respective one of said plurality of accessible materials;
maintaining respective data associated with said plurality of accessible materials for each of said plurality of users; and
providing said respective data maintained for one of said users to another of said users.

2. A method for indicating to a plurality of users relationships among a plurality of accessible materials according to claim 1, wherein each one of said plurality of accessible materials corresponds to a respective one of a plurality of web pages, said method further comprising the steps of:
allowing said user to access one of said web pages; and
indicating that said one of said web pages has been accessed.

3. A method for indicating to a plurality of users relationships among a plurality of accessible materials according to claim 1, further comprising the step of displaying indications of relationships among ones of said plurality of icons.

4. A method for indicating to a plurality of users relationships among a plurality of accessible materials according to claim 1, further comprising the step of generating a list which includes ones of said accessible materials and which further includes further accessible materials which do not correspond to displayed icons.

5. A method for indicating, to a plurality of users, relationships among a plurality of accessible materials according to claim 4, further comprising the step of indicating on said list which of said accessible materials correspond to displayed icons.

6. A method of indicating web frame access comprising the steps of:
writing Uniform Resource Locators (URLs) corresponding to a plurality of pages to a database using hidden frames;
tracking further frames corresponding to said URLs in a web browser to identify said further frames; and
reproducing window configuration for one of said further frames in said web browser independent of window configuration updates.

7. A method for indicating to a plurality of users relationships between a plurality of accessible materials according to claim 1, wherein each one of said plurality of accessible materials corresponds to a respective one of a plurality of files on a shared disk.

8. A method of indicating web page access by a plurality of users, said method comprising the steps of:
displaying to each of said users a plurality of icons which represent a plurality of web pages;
indicating for one of said users which web pages of said plurality of web pages have been accessed by said one of said users; and
indicating for another of said users which web pages of said plurality of web pages have been accessed by said one of said users.

9. A method of indicating web page access according to claim 8, further comprising the steps of:
maintaining for each of said users respective data associated with ones of said web pages; and
sharing said respective data between ones of said users.

10. A method of indicating web page access according to claim 8, wherein web page access includes retrieval of a page from one of said web pages, said page including a plurality of frames which each have an associated one of a plurality of Uniform Resource Locators (URLs), said method further comprising the steps of:
generating a shorthand string which is a common portion of said plurality of URLs; and
accessing ones of said frames using said shorthand string.

11. A method of indicating web page access according to claim 8, further comprising the step of displaying indications of relationships among ones of said plurality of icons.

12. A method of indicating web page access according to claim 8, further comprising the steps of:
maintaining data associated with ones of said plurality of icons, said data including text;
indicating each of said icons with which the data is associated; and
making said data visible responsive to a request therefor.

13. A method of indicating web page access according to claim 8, further comprising the steps of:
assigning for each icon at least a title a URL and an age attribute; and
specifying a format for displaying the title and age attributes on the map.

14. A method of indicating web page access, said method including the steps of:
providing a map which is empty;
adding to said map respective icons corresponding to respective web pages when said respective web pages are visited;
providing a display of icons corresponding to said map;
displaying indications between corresponding icons on said map as a user traverses among said web pages.

15. A method of indicating web page access according to claim 14, further comprising the steps of:
visiting a first plurality of said web pages in a first browser window;
visiting a second plurality of said web pages in a second browser window; and
displaying said first and second plurality of web pages by respective first and second graphs which are disconnected; and,
displaying said first and second graphs as connected if one of said second plurality of web pages is visited using said first browser.

16. A method of indicating web page access according to claim 14, further comprising the step of maintaining a list of all of said web pages visited, wherein said list identifies web pages which correspond to displayed icons and those which do not correspond to displayed icons.

17. A method of indicating web page access according to claim 16, further comprising the steps of:
designating one of said web pages which does not correspond to any of said plurality of displayed icons; and
creating an icon corresponding to said designated one of said web pages.

18. A method of indicating web page access according to claim 14, further comprising the steps of removing from display an indication of a relationship between two icons and deleting at least one of said icons from the icons to be displayed.

19. A method of indicating web page access according to claim 14, further comprising the step of bringing into view one or more icons when a wab page corresponding to an icon is viewed. wherein said icons form parent/child relationships further comprising the step of removing a child of one of said parent/child relationships from view.

20. A method of indicating web page access according to claim 14, wherein at least one of said icons is decorated to indicate that there are further icons removed from view.

21. A method of indicating web page access according to claim 14, wherein one of said icons is designated as a root and all icons which succeed said root are displayed.

22. A method of indicating web page access according to claim 14, wherein said indications are each assigned one of a plurality of hierarchical levels, further comprising the step of displaying ones of said icons coupled to a selected one of said plurality of hierarchical levels.

23. A method of indicating web page access according to claim 14, wherein a plurality of attributes are associated with each of said icons and wherein ones of said attributes are modifiable.

24. A method of indicating web page access according to claim 14, wherein ones of said pages opened in a previous session of web page access are opened for a subsequent session of web page access.

25. A method of indicating web page access according to claim 14, further comprising the step of polling open windows to identify one or more Uniform Resource Locators corresponding to accessed web pages.

26. A method of indicating web page access according to claim 14, further comprising the step of writing a Uniform Resource Locator for one of said web pages to a database using a hidden frame.

27. A method of indicating web page access according to claim 14, further comprising the step of reproducing window configuration of at least one of said web pages from within a web browser independent of window configuration updates.

28. A method of indicating web page access according to claim 14, further comprising the step of storing data associated with said window configuration for any of said web pages on a server.

29. A method of indicating web page access according to claim 14, further comprising the step of adding at least one node to the map using the nearest neighbor algorithm.

30. An apparatus for indicating to a plurality of users, relationships among a plurality of accessible materials, using a browser, visualization and tracking facilities, a database interface and a database, comprising:
means for displaying a plurality of icons, each corresponding to a respective one of said plurality of accessible materials;
means for maintaining respective data associated with said plurality of accessible materials for each of said plurality of users; and
means for providing said respective data maintained for one of said users to another of said users.

31. A carrier including a computer program for causing a computer to indicate to a plurality of users, relationships among a plurality of accessible materials, said computer program comprising:
means for causing the computer to display a plurality of icons, each corresponding to a respective one of said plurality of accessible materials;
means for causing the computer to maintain respective data associated with said plurality of accessible materials for each of said plurality of users; and
means for causing the computer to provide said respective data maintained for one of said users to another of said users.

32. A carrier according to claim 31, wherein each one of said plurality of accessible materials corresponds to a respective one of a plurality of web pages and said computer program further comprises:
means for causing the computer to allow said user to access one of said web pages; and
means for causing the computer to indicate that said one of said web pages has been accessed.

33. A carrier according to claim 32, wherein the computer program further comprises means for causing the computer to display indications of relationships among ones of said plurality of icons, wherein said relationships correspond to either hyperlinks or user defined relationships among the ones of said plurality of web pages.

34. A system for tracking a user's accessing of data independent of any server used to access the data comprised of:
a database server for storing the data;
a tracking component for capturing the data; and,
a visualization component for viewing the data.
